(19) United States
(12) Patent Application Publication
(10) Pub. No.: US 2026/0277920 A1
(43) Pub. Date: Sep. 17, 2026

(54) AI-DRIVEN NETWORK HEALTH CHECK AND CONFIGURATION MANAGEMENT FOR DATA CENTERS

(71) Applicant: NVIDIA Corporation, Santa Clara, CA (US)

(72) Inventor: Saikrishna Mallampeta, Frisco, TX (US)

(21) Appl. No.: 19/076,928

(22) Filed: Mar. 11, 2025

(51) Int. Cl. G06F 16/2458; G06F 16/242; G06F 16/248

(52) U.S. Cl. CPC G06F 16/2465; G06F 16/243; G06F 16/2433; G06F 16/248

(57) ABSTRACT

A method and system for performing health checks, the method comprising: processing an input including a natural language query requesting deployment information for a portion of a data center using a first artificial intelligence (AI) model, wherein the first AI model outputs a query instruction based on the natural language query, obtaining, using the query instruction, first log data from one or more devices of the data center, determining, based on the first log data and stored data center configuration information, a response to the natural language query, wherein the response comprises the deployment information for the portion of the data center, and causing the response to the natural language query to be visually rendered in a graphical user interface (GUI).

### TECHNICAL FIELD

At least one embodiment pertains to data center deployment. For example, at least one embodiment pertains to AI-driven network health check and configuration management for data centers.

### BACKGROUND

Data centers are complex systems with many interrelated components. Deploying a data center can be similarly complex.

### BRIEF DESCRIPTION OF DRAWINGS

Various embodiments in accordance with aspects of the disclosure will be described with reference to the drawings, in which:

FIG. 1A illustrates an example system, according to some aspects of the disclosure.

FIG. 1B illustrates an example data base, according to some aspects of the disclosure.

FIG. 2 is a block diagram of an example communication interconnect, according to some aspects of the disclosure.

FIG. 3 is a block diagram illustrating a system architecture for performing a network health check, according to some aspects of the disclosure.

FIG. 4A is an example graphical user interface (GUI) that renders a visual representation of a network health via a client device, according to some aspects of the disclosure.

FIG. 4B is an example GUI that renders a visual representation of a network health via a client device, according to some aspects of the disclosure.

FIG. 4C is an example GUI that renders a visual representation of a network health via a client device, according to some aspects of the disclosure.

FIG. 4D is an example GUI that renders a visual representation of a network health via a client device, according to some aspects of the disclosure.

FIG. 4E is an example GUI that renders a visual representation of a chatbot via a client device, according to some aspects of the disclosure.

FIG. 4F is an example graphical user interface (GUI) 400F that renders a visual representation of a server rack, according to some aspects of the disclosure.

FIG. 5 is a flow diagram of an example method for performing a network health check using a system architecture, according to some aspects of the disclosure.

FIG. 6 is a flow diagram of an example method for performing a network health check using a system architecture, according to some aspects of the disclosure.

FIG. 7 is a block diagram illustrating an exemplary computer system which can be a system with interconnected devices and components, a system-on-a-chip (SOC), or some combination thereof, according to some aspects of the disclosure.

FIG. 8 is a block diagram illustrating an electronic device for utilizing a processor, according to some aspects of the disclosure.

FIG. 9 is a block diagram of a processing system, according to some aspects of the disclosure.

FIG. 10 is a block diagram of a computing system having two processing devices coupled to each other and multiple networks according to some aspects of the disclosure.

FIG. 11 is a block diagram of a computing system having a CPU and a GPU in a single integrated circuit according to at least one embodiment.

FIG. 12 is a block diagram of a computing system having tensor core GPUs according to at least one embodiment.

FIG. 13 illustrates a distributed system, according to some aspects of the disclosure.

FIG. 14 illustrates an exemplary data center, according to some aspects of the disclosure

FIG. 15 illustrates a system that includes client-server network formed by a plurality of network server computers which are interlinked, according to some aspects of the disclosure.

FIG. 16 illustrates a system including a computer network connecting one or more computing machines, according to some aspects of the disclosure.

FIG. 17A illustrates a networked computer system, according to some aspects of the disclosure.

FIG. 17B illustrates a networked computer system, according to some aspects of the disclosure.

FIG. 17C illustrates a networked computer system, according to some aspects of the disclosure

FIG. 18 illustrates a fat tree topology for a data center, according to some aspects of the disclosure.

FIG. 19 illustrates an example data center, according to some aspects of the disclosure.

### DETAILED DESCRIPTION

Data centers are complex systems with many interrelated components. Deploying a data center can be similarly complex. Some data center deployment plans are fragmented and rely on multiple configuration documents. For example, each component in the data center may have a set of instructions or configuration settings for how to set up the particular component or family of components. However, there may be little to no formal documentation on how to specifically connect each of the different components of the data center into a single unified system (e.g., a functioning data center). Data fragmentation may be further worsened when multiple configuration documents contain the same or similar information. Similarly, when multiple components of the data center share a common configuration setting (for example, a set of administrator credentials), updating this setting in the configuration documents for one component may not automatically update it in all other configuration documents. This may lead to confusion for operators who are installing and initializing the data center.

Configuration settings for a data center may often be stored in documents that are not designed for advanced data management, such as basic spreadsheet or word processing documents. These basic document types may lack features such as strong data protection, version control, and/or integration with other data management programs. As a result, these configuration settings often rely on the manual entry or copying of entries between documents, which can cause information to be easily deleted, whether accidentally or intentionally.

Another challenge can be the lack of a centralized way to search through the configuration documents. Since the configuration settings are pulled from multiple configuration documents, there is no single system to quickly locate specific details. This makes searching for information time-consuming and inefficient. Furthermore, the documents do not connect to any tools or systems that allow automated testing of the configured system. Any verification or testing is generally done manually or using separate processes, which increases the risk of errors. These combined issues—data fragmentation, reliance on basic tools and manual processes, and a lack of search and testing features—add further complications to the already complex task of configuring a data center.

Aspects of this disclosure address these and other challenges by implementing a system architecture for network health checks of data center deployments. The system architecture can store the configuration settings for each of the data center components of a data center in a centralized repository or “single source of truth.” The system architecture can provide various graphical user interfaces (GUIs) for receiving configuration information for different components of the data center. For example, the system architecture may provide a GUI that appears similar to a spreadsheet or word processing document to a user. The user can provide configuration settings through the GUI, which can be stored in the centralized repository. Information stored in the centralized repository can be accessible for use in configuration settings of other components of the data center. The system architecture can integrate testing systems that can be used to test the functionality of the data center, or a component of the data center. Additionally, the system architecture can implement a search feature that searches configuration settings of the various data center components, including information stored in the centralized repository. The system architecture may store design or component information documents as well, such as component specifications, component technical manuals, and or component operating manuals. These component information documents may be searchable as well through the search feature of the system architecture.

In some embodiments, the system architecture can further include one or more artificial intelligence (AI) models that facilitate the interaction between a user and features of the system architecture. For example, an artificial intelligence (AI) chat bot may be integrated with the search function, and/or an AI model can be trained to interface with components of the data center to perform verification tests. The AI chat bot may be trained to receive user inquiries regarding a data center deployment, to gather information about tests performed on the data center deployment, to compare the gathered information to plans for the data center deployment, and to generate reports responsive to the received inquiries based on the comparison of the gathered information to the plans for the data center deployment.

Advantages of the disclosure include, but are not limited to, an increased efficiency in data center deployment and a decreased number of errors in data center configurations and deployment.

Processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a small language model, a system for performing generative AI operations using a large language model, a system for performing generative AI operations using a vision language model, a system for performing generative AI operations using a multimodal language model, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

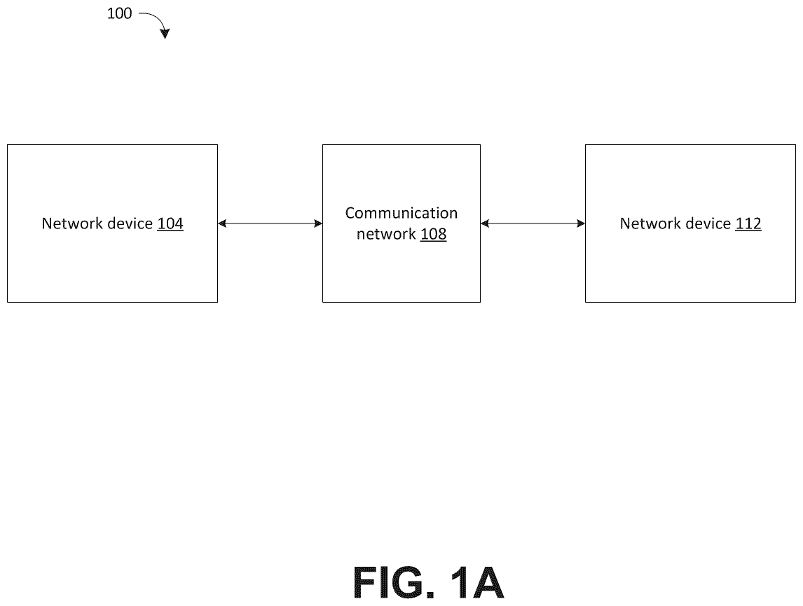

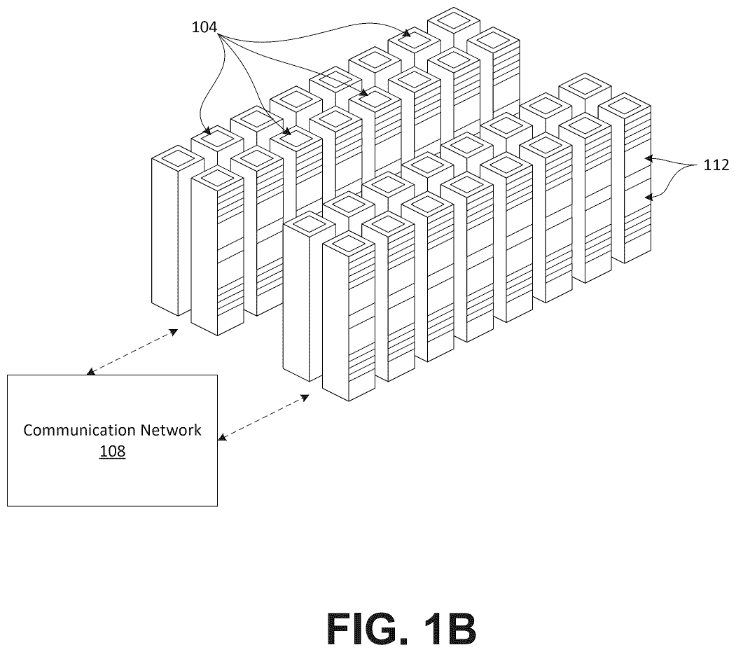

FIG. 1A illustrates a system 100, according to some aspects of the disclosure. The system 100 includes a network device 104, a communication network 108, and a network device 112 (also referred to hereinafter as a “network element”). In at least one example embodiment, network devices 104 and 112 may correspond to a network switch (e.g., an Ethernet switch), a network interface controller (NIC), or any other suitable device used to control the flow of data between devices connected to communication network 108. Each network device 104 and 112 may be connected to one or more of Personal Computer (PC), a laptop, a tablet, a smartphone, a server, a collection of servers, a GPU, or the like. In one specific, but non-limiting example, each network device 104 and 112 includes multiple network switches in a fixed configuration or in a modular configuration. The switches within each layer (e.g., edge layer, aggregation layer, core layer) may be 1U switches, where “1U” refers to the industry-standard size for rack-mounted switches and servers. The switches may be electrical switches, optical switches, hybrid electro-optical switches, or any combination thereof. The switches may be implemented with suitable hardware and/or software that enables the routing of signals in the appropriate domain. For example, an electrical switch may include receivers that receive and convert optical signals into electrical signals for routing within the electrical switch. A receiver of an electrical switch may include a transimpedance amplifier (TIA), a photodetector, and a controller which all serve to convert the optical signals into electrical signals. Each electrical switch may further include transmitters that convert electrical signals routed within the electrical switch into optical signals for output to another switch (optical or electrical) within the system. For example, a transmitter of an electrical switch may include a light source, a modulator, and a controller that controls the modulator and light source. In some embodiments, receiver/transmitter pairs may be integrated into a single transceiver. Each electrical switch may also include internal switching circuitry for routing electrical signals within the electrical switch.

In some embodiments, the network device 104 can be a rack in a data center, as illustrated in FIG. 1B. Data centers may include multiple network switches in a particular topology, such as a fat tree topology, a slim fly topology, or indirect network topology (e.g. folded-Clos or a dragonfly topology), and/or the like. The specifications and makeup of the network switches in the topology affects the overall network performance (e.g., bandwidth capability) of the data center.

High performance computing clusters, and/or the like are often formed of various computing components or networked devices, and communication networks formed of electrical and/or optical devices may be used to enable communication between the networked devices forming these implementations.

For example, the network device 104 may be a centralized facility designed to house computing resources and related components. The network device 104 may operate to support the infrastructure required for advanced computational tasks, for efficient, secure, and reliable operations. The network device 104 may include the building and structural components, including power supplies, cooling systems, fire suppression systems, and physical security measures that are configured to maintain optimal operating conditions and/or protect the equipment from environmental hazards and unauthorized access. An example network device 104 may include high-performance servers or compute nodes, often arranged in racks, such as those illustrated in FIG. 1B, and connected through high-speed networks as described herein. These servers may include processors (e.g., central processing units (CPUs), graphics processing units (GPUs), data processing units (DPUs) and/or the like), memory (e.g., RAM), and storage solutions (e.g., hard disk drives (HDDs), solid state drives (SSDs), and/or the like. The hardware configuration may be designed for parallel processing and high throughput, catering to the demands of high-performance computing (HPC) applications.

The network device 104 may include high-speed network equipment, such as network switches, routers, firewalls, and/or the like to facilitate fast and secure data transmission within the network device 104 (e.g., between the servers or compute nodes) and between external networks. The network device 104 may facilitate communication between servers or compute nodes through a network topology that ensures efficient data exchange, minimizes latency, and maximizes bandwidth. The network topology may dictate how various network devices, such as switches and routers, are interconnected for data flow. By implementing an effective network topology, the network device 104 may support high-performance computing tasks. Examples of various network topologies may include hierarchical networking topologies such as the fat tree topology, Slim Fly topology, Dragonfly topology, and/or the like.

Examples of the communication network 108 that may be used to connect the network devices 104 and 112 include an Internet Protocol (IP) network, an Ethernet network, an InfiniBand (IB) network, a Fibre Channel network, an NVLink fabric, the Internet, a cellular communication network, a wireless communication network, combinations thereof (E.g., Fibre Channel over Ethernet), variants thereof, and/or the like. In one specific, but non-limiting example, the communication network 108 is a network that enables communication between the network devices 104 and 112 using Ethernet technology.

Each network device 104 and 112 may be connected to a communication network 108 that has multiple network switching layers. The number of network devices 104 and 112 that may be connected to the communication network 108 can be increased by increasing the radix of the communication network 108. The radix of the communication network 108 is increased by increasing the radix of each network layer in the communication network 108. The radix of each network layer is increased using optical shuffle boxes that implement wavelength division multiplexing as described herein below in embodiments. The communication network 108 can include one or more electrical switches, optical switches, electrooptical transceivers, or the like, as described herein below.

The communication network 108 may communicably couple the network device 104 with network device 112 and other external devices for data exchange and connectivity. Examples of the communication network 108 may include an Internet Protocol (IP) network, an Ethernet network, an InfiniBand (IB) network, a Fibre Channel network, an NVLink fabric, the Internet, a cellular communication network, a wireless communication network, combinations thereof (e.g., Fibre Channel over Ethernet), variants thereof, and/or the like. The ability of the communication network 108 to incorporate multiple network types and configurations may allow the network device 104 to adapt to diverse application needs, from general data communication to specialized HPC tasks. As described herein, the communication network 108 may leverage various optical components to establish communication links (e.g., communicably couple) between components in the computing system 1000. As such, the communication network 108 may include various optical devices, transceivers, modules, and/or the like that are configured to generate optical data signals (e.g., provide optical transmitter functionality) and/or receive optical data signals (e.g., provide optical receiver functionality).

The network device 112 may include a variety of computing devices capable of transmitting and receiving signals over the communication network 108. The network device 112 may range from personal computing devices to complex server configurations. Examples include Personal Computers (PCs), laptops, tablets, smartphones, and servers. The network device 112 may facilitate user interactions with the network device 104, allowing for data input, retrieval, and processing from remote locations. In addition to individual computing devices, the network device 112 may also include collections of servers or additional data centers. For instance, these could be other data centers similar to or the same as network device 104. Such an interconnection may allow for the formation of a distributed computing environment for improved redundancy, load balancing, and disaster recovery capabilities. By linking multiple data centers, the system 100 may leverage geographically dispersed resources, optimizing performance and ensuring high availability.

As described herein, the network device 104 and/or the network device 112 may include storage devices and processing circuitry for executing computing tasks, such as controlling the flow of data internally and over the communication network 108. The processing circuitry may include software, hardware, or a combination thereof. For example, the processing circuitry may include a memory containing executable instructions and a processor (e.g., a microprocessor) that executes these instructions. The memory may correspond to any suitable type of memory device or collection of memory devices configured to store instructions. Non-limiting examples of suitable memory devices include Flash memory, Random Access Memory (RAM), Read Only Memory (ROM), variants thereof, combinations thereof, or similar technologies. In specific embodiments, the memory and processor may be integrated into a common device, such as a microprocessor with integrated memory. Additionally, or alternatively, the processing circuitry may comprise hardware components, such as an application-specific integrated circuit (ASIC). Other non-limiting examples of processing circuitry include Integrated Circuit (IC) chips, CPUs, GPUs, microprocessors, Field Programmable Gate Arrays (FPGAs), collections of logic gates or transistors, resistors, capacitors, inductors, and diodes. Some or all of the processing circuitry may be provided on a Printed Circuit Board (PCB) or a collection of PCBs. It should be appreciated that any appropriate type of electrical component or collection of electrical components may be suitable for inclusion in the processing circuitry.

In addition, although not explicitly shown, the present disclosure contemplates that the network device 104 and network device 112 may include one or more communication interfaces for facilitating wired and/or wireless communication between one another and other unillustrated elements of the system 100. These communication interfaces may include a variety of technologies, including but not limited to Ethernet ports, fiber optic connections, Wi-Fi® transceivers, Bluetooth® modules, and cellular communication modules for integration and interoperability among the various components within the system 100.

Furthermore, the present disclosure contemplates that the system 100 may include additional components and functionalities. For example, the network architecture may include, without limitation, additional processing units, specialized accelerators (such as Tensor Processing Units or TPUs), enhanced security modules, and redundant power supplies. The inclusion of these elements may be intended to ensure that the system 100 is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the system 100.

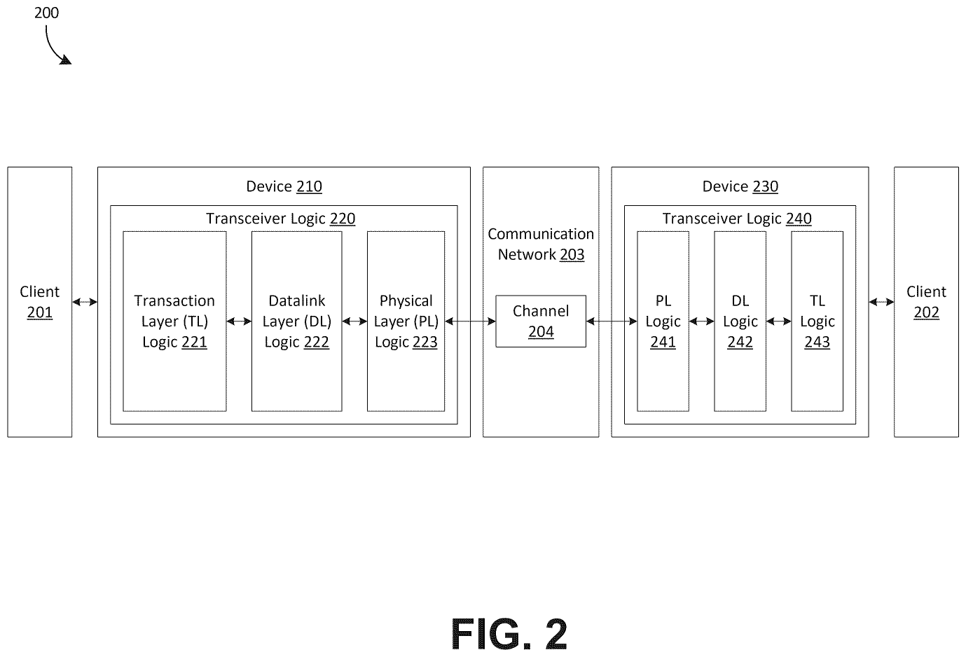

FIG. 2 is an example block diagram of a communication interconnect 200, according to some aspects of the disclosure. The communication interconnect 200 may be used to connect two or more components of the data center described above with reference to FIG. 1A-B.

The communication interconnect 200 includes a client 201 coupled to a device 210 and a client 202 coupled to a device 230. The device 210 and the device 230 are coupled together via the communication network 203 to transmit and receive data. In some embodiments, the transmitted and received data is in a data frame. Device 210 includes transaction layer (TL) layer logic 221, datalink layer (DL) layer logic 222, and physical layer (PL) logic 223. The device 230 similarly includes TL logic 241, DL logic 242, and PL logic 243. The function and operation of the device 210 described herein similarly apply to the function and operation of the device 230 unless explicitly noted.

In some embodiments, the client 201 is an integrated circuit of a Personal Computer (PC), a laptop, a tablet, a smartphone, a server, a collection of servers, or the like. In some embodiments, the client 201 may correspond to any appropriate type of device that communicates with other devices also connected to a common type of communication network 203.

The device 210 can be an integrated circuit of a graphics processing unit (GPU), a switch (e.g., a high-speed network switch), a network adapter, a central processing unit (CPU), a data processing unit (DPU), a neural processing unit (NPU), an application-specific integrated circuit (ASIC), a field programmable gate array (FPGA), a network interface card (NIC), or the like. The device 210 can be implemented in components in clients referred to as machines, computers, servers, network devices, or the like (e.g., client 201).

The communication interconnect 200 allows the client 201 to communicate with the client 202 via the communication network 203 and devices 210-230, respectively. The client 201 can cause the device 210 to transmit and receive data with the client 202 (or another client coupled to the communication network 203 via another respective device) via the channel 204. Similarly, the client 202 can cause the device 230 to transmit and receive data across the communication network 203.

Examples of the communication network 203 that may be used to connect the device 210 and device 230 include wires, conductive traces, bumps, terminals, optical fibers, or the like. In other embodiments, the communication network 203 can be a Peripheral Component Interconnect Express (PCIe) interconnect. PCIe is a high-speed interface standard used to connect various hardware components. It can be an interconnect for devices such as graphics cards (GPUs), solid-state drives (SSDs), network cards, and other peripherals. PCIe offers a scalable, high-speed, and point-to-point connection between devices, including CPUs, GPUs, memory, and the like. In other embodiments, the communication network 203 can be a high-speed interconnect, such as an interconnect that deploys the NVLink technology. The NVLink interconnect can be a GPU-GPU interconnect used between GPUs, a CPU-GPU interconnect between GPUs and CPUs, or an interconnect used between other devices. NVLink offers a higher bandwidth and lower latency than traditional PCIe connections, which are typically used in computing hardware. NVLink is especially useful in scenarios that require massive parallel processing, such as artificial intelligence (AI), machine learning, deep learning, high-performance computing (HPC), and data analytics. For example, in NVIDIA's DGX systems and high-end gaming or AI workstations, NVLink helps GPUs exchange data at speeds that are necessary for demanding tasks like real-time ray tracing or training neural networks. In one specific, but non-limiting example, the communication network 203 is a network that enables data transmission between the device 210 and device 230 using data signals (e.g., digital, optical, wireless signals), clock signals, or both. The embodiments described herein can be utilized in a system with a high-speed, scalable switch, such as a switch using the NVSwitch technology. NVSwitch is a high-speed, scalable switch developed by NVIDIA that facilitates data communication between multiple GPUs in a system, allowing them to work together more efficiently by providing high-bandwidth, low-latency interconnections. The NVSwitch serves as a central hub or high-bandwidth fabric that interconnects all the GPUs in a system, enabling each GPU to communicate with every other GPU quickly and efficiently. The NVSwitch can be coupled between other types of devices, such as CPUs, accelerators, memory, or the like. The NVSwitch can be used for tasks requiring intense computation and collaboration between multiple GPUs, such as AI model training, scientific simulations, and large-scale data processing. The embodiments described herein can be used in a high-performance computing system, such as a computing system modeled after NVIDIA's DGX systems, which are designed specifically for artificial intelligence (AI), deep learning, and high-performance computing (HPC) workloads. DGX systems are optimized for large-scale GPU computation and parallel processing, integrating multiple GPUs, high-bandwidth interconnects, and software frameworks tailored for AI and HPC tasks. In at least one embodiment, a system for high-speed network communication includes a processing unit, a network interface comprising a receiver or transceiver with the control logic, as described herein.

Other examples for the communication network 203 can include other chip-to-chip or die-to-die interconnects, such as GRS, LPI (low power interface) or LLI (low latency interface).

In embodiments, the device 210 can interface with the client 201 to transmit and receive data over a two-way communication stream (e.g., channel 204 of the communication network 203). The channel 204 can be PCIe, NVLink, Ethernet, InfiniBand, Ground Reference Signal (GRS), C2C, D2D, or the like. As illustrated, device 210 is single device which includes transceiver logic 220 (and device 230 respectively includes the transceiver logic 240). The transceiver logic 220 can be used to send and receive data signals via the communication network 203. In some embodiments, the device 210 can include a transceiver device, transmitter device, or receiver device, which may include some or all of the transceiver logic 220.

The transceiver logic 220 includes suitable software, firmware, and/or hardware for receiving digital data from a source (e.g., client 201) and outputting data signals according to the digital data for transmission over the communication network 203. In some embodiments, the transceiver logic 220 can generate and transmit frames including data from the client 201 over the communication network 203 to the device 230. For example, the transceiver logic 220 can generate and transmit frames across the channel 204 to the device 230.

The transceiver logic 220 also includes suitable software, firmware, and/or hardware for receiving digital data from a device over the communication network 203 and outputting digital data for further processing by a recipient (e.g., client 201). For example, the transceiver logic 220 may include components for receiving processing signals to extract the data for storing in a memory. In some embodiments, the transceiver logic 220 can receive and process frames including data from the client 201 over the communication network 203 from another device 230. For example, the transceiver logic 240 can receive and process frames including data from the client 201 across the channel 204 from the device 230. In some embodiments, the transceiver logic 220 receives an incoming signal and samples the incoming signal to generate samples, such as using an analog-to-digital converter (ADC). The ADC can be controlled by a clock-recovery circuit (or clock recovery block) in a closed-loop tracking scheme. The clock-recovery circuit can include a controlled oscillator, such as a voltage-controlled oscillator (VCO) or a digitally-controlled oscillator (DCO) that controls the sampling of the subsequent data by the ADC.

The transceiver logic 220 include multiple processing elements, such as is one or more of transaction layer logic 221, datalink layer logic 222, or physical layer logic 223, as illustrated. Similarly, the transceiver logic 240 of the device 230 can include corresponding processing elements such as TL logic 241, DL logic 242, and PL logic 243, as illustrated. The transceiver logic 220 or selected elements of the device 210 may take the form of a pluggable card or respective controller for the device 210. For example, the transceiver logic 220 or selected elements of the device 210 may be implemented on a network interface card (NIC). In an alternative example, the functions of the transceiver logic 220 can be performed by separate devices of the communication interconnect 200. For example, a first device can include the transaction layer logic 221, a second device can include the datalink layer logic 222, and a third device can include the physical layer logic 223.

The transaction layer logic 221 can interface directly with the client 201. The transaction layer logic 221 can receive data from the client (e.g., “client data”) that is to be transmitted across the communication network 203. In some embodiments, the transaction layer logic 221 can divide the data received from the client into predetermined quantities. For example, data received from the client 201 may be several kilobytes of data, and the transaction layer logic 221 can break the data down into evenly sized chunks of one byte each. Additional predetermined “chunk” sizes or data quantities are considered.

The datalink layer logic 222 can receive the predetermined quantity of data from the transaction layer logic 221 and packaged the received data into a frame to be transmitted across the communication network 203. In some embodiments, a frame of data includes the quantity of data (e.g., one byte of data).

The physical layer logic 223 interfaces directly with the communication network 203 to transmit across the communication network 203 to the device 230, where the PL logic 243 provides the received data to the DL logic 242. The DL logic 242 extracts the data from a received frame and provides the extracted data to the TL logic 241. The TL logic 241 can provide the extracted data to the client 202. Similarly, data can be sent from TL logic 241 to DL logic 242 packages the data into a frame. The frame can be sent via the physical layer logic 223 of the device 210. At the datalink layer logic 222, extracts the data from the received frame. The transaction layer logic 221 obtains the extracted data from the datalink layer logic 222 and provides the extracted data to the client 201. In some embodiments, the TL logic 241 assembles multiple sets of extracted data to provide to the client 202 simultaneously.

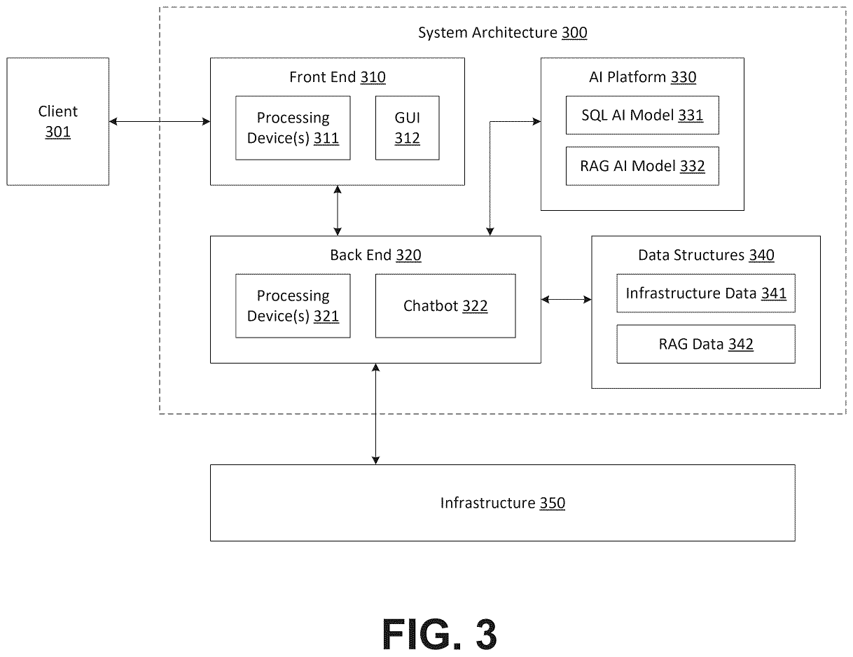

FIG. 3 is a block diagram illustrating a system architecture for performing a network health check of a data center deployment, according to some aspects of the disclosure.

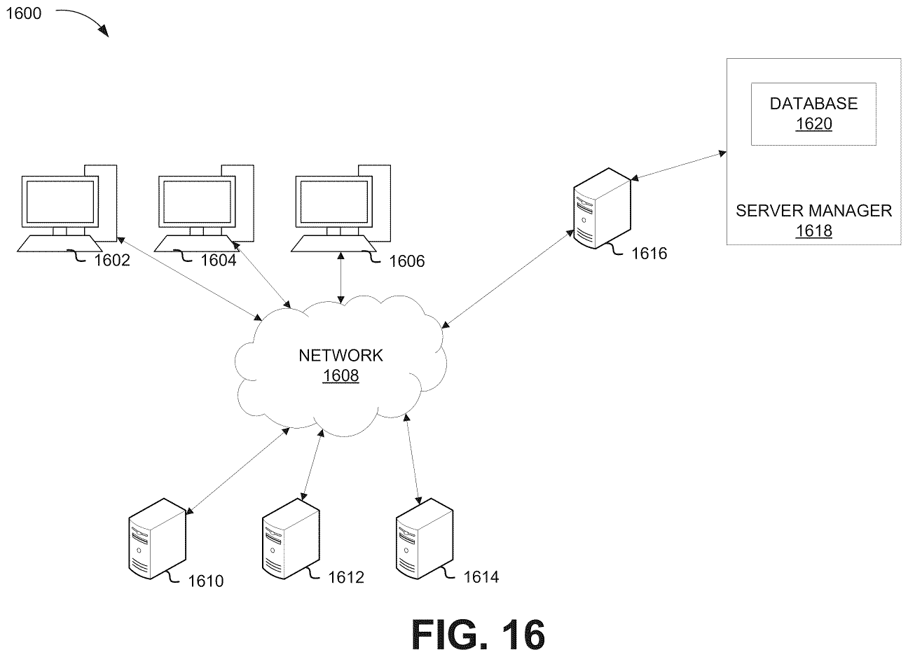

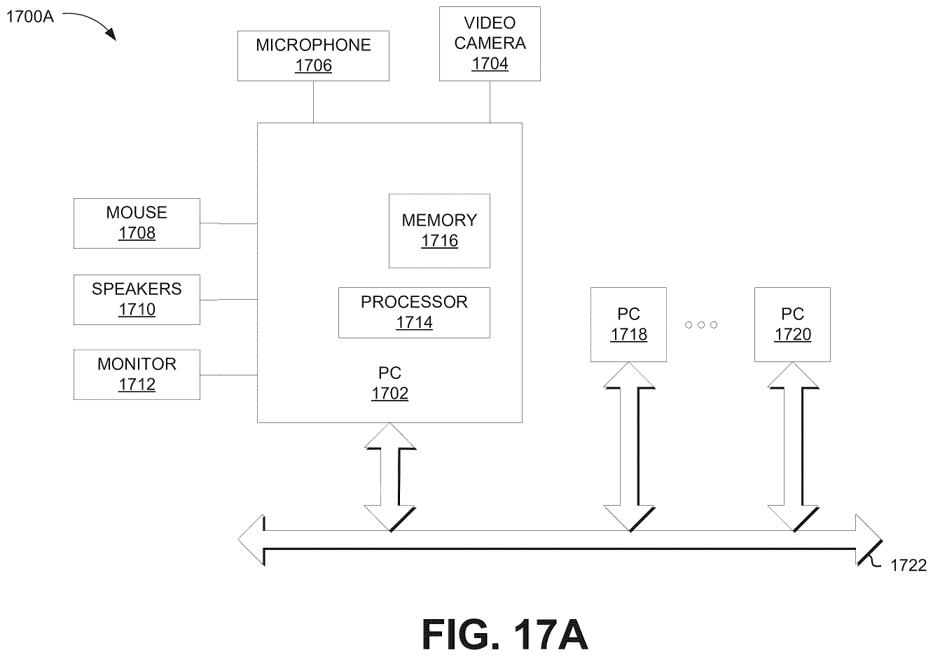

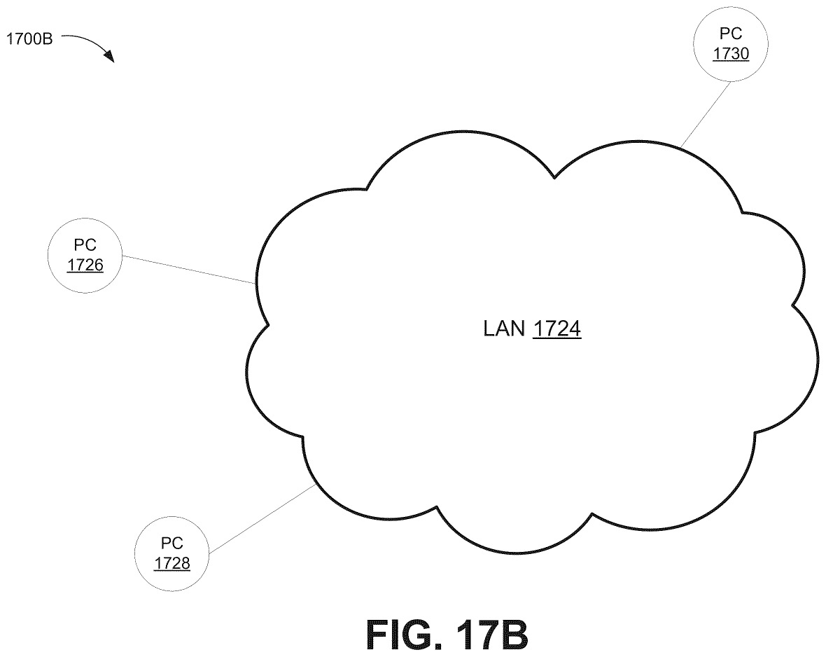

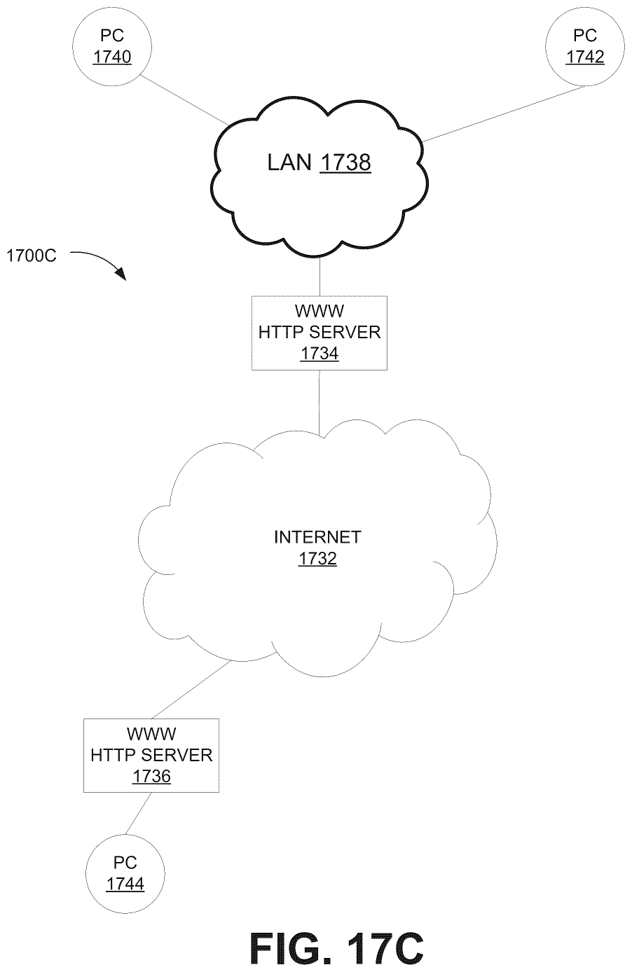

A client 301 is connected to the system architecture 300, which includes a front end 310, a back end 320, an AI platform 330, and a data structure(s) 340. The system architecture 300 interfaces with the infrastructure 350. The client 301 may be, for example, a computing device such as a personal computer, laptop computer, desktop computer, mobile phone, tablet computer, etc. controlled by a user. The infrastructure 350 includes the physical components of the data center, such as racks, servers, processors (e.g., central processing units (CPUs), graphics processing units (GPUs), data processing units (DPUs), etc.), network devices, network switches, and the like. Additional details regarding the components in a data center are described below, for example in FIGS. 16-17C.

The system architecture 300 can be a secure environment. That is, information that is provided to the system architecture 300 (e.g., from the client 301) is accessible only by authorized parties. For example, the back end 320 may request information from a third party (e.g., such as when the AI platform is not included in the system architecture as further described below). However, the transfer of information between the back end 320 and the third party (if applicable) can be through a secure channel, and may be encrypted. In another example, data stored in the data structure 340 of the system architecture 300 may not be accessible outside of the system architecture 300. That is, the client 301 may interact with the data structure 340 through the other components of the system architecture (e.g., the front end 310 and the back end 320). In this way, sensitive information that is stored or processed by the system architecture such as user credentials, trade secret information, customer information, etc. are protected from unauthorized access.

The client 301 interacts with the system architecture 300 through the front end 310. As used herein, “front end” can refer to a client-facing portion of a software application, system, or technology stack (e.g., the system architecture 300). The front end 310 is the interface or component that the client 301 directly interacts with to perform tasks, access information, or execute actions within the system architecture 300. The front end 310 can encompass all visual, interactive, and presentation elements that facilitate communication between the client 301 and the other elements of the system architecture 300 (e.g., the back end 320, AI platform 330, data structure 340, and infrastructure 350).

In embodiments, client 301 and front end 310 implement a security layer to secure communications therebetween. For example, client 301 and front end 310 may implement WSO2 authentication. The security layer may encrypt messages of a sender (e.g., client or front end) and decrypt messages of a receiver (e.g., front end or client) to ensure a secure encrypted communication. In one embodiment, client 301 includes credentials for accessing system architecture 300. The credentials may be used to identify and authenticate a user of client 301.

The front end 310 includes one or more processing devices 311 and a GUI 312. The processing devices 311 can receive input from the client 301 via the GUI 312. In some embodiments, the GUI 312 is presented in a window (such as a window of an application) on the client 301. The processing devices 311 can modify the GUI 312 based on inputs received from the client 301, and based on information obtained from the other elements of the system architecture (e.g., from the back end 320, from the AI platform 330, from data structure 340, etc.). In some embodiments, the GUI 312 can be modified based in part on inputs received from the client 301. That is, based on at least the inputs received from the client 301, and on other factors (such as information obtained from other elements of the system architecture). In some embodiments, the front end 310 is an interface that is configured to be useable by the client 301 to interact with the back end 320. In some embodiments, the front end 310 can format data or information obtained or received from the back end 320. For example, the back end 320 can provide numerical data to the front end 310, and the front end 310 can render the provided numerical data as one or more graphs, figures, or visual elements.

In some embodiments, the front end 310 renders data or information from the system architecture 300 in the GUI 312 based on input received from the client 301 and data received from the back end 320, AI platform 330 and/or data structures 340. For example, the client 301 can provide data such as multimodal input (e.g., textual input, etc.), item selection, or the like to the front end 310. The front end 310 can process this data and interact with the back end 320 via one or more application programming interfaces (APIs). These APIs can allow for the exchange of data between the front end 310 and the back end 320 without exposing core logic of the system architecture 300 or the back end 320. In some embodiments, the front end 310 can provide information to the client 301 as one or more actions are being performed by the system architecture 300. For example, if the client 301 provides a natural language input that requests a certain action be performed by the system architecture (e.g., that a network connectivity test be performed on components of the infrastructure 350, etc.), the front end 310 can display the commands that are used and/or generated to comply with the natural language input. In some embodiments, the front end 310 can provide a means, such as a text box, selection button or the like, for the client 301 to interact with the commands that are used to comply with the natural language input. For example, the client 301 may provide the input, “Perform a ping test between network switch ‘A’ and network switch ‘B.’” In response, as the instructions for each component may be generated or identified to perform the ping test, the front end 310 may visually render the syntax of these instructions in the GUI 312 for the client 301. In some embodiments, the front end 310 may additionally prompt the client 301 before proceeding with the generated or identified instructions (e.g., the query instructions generated or identified in response to the natural language request provided by the client 301). In some embodiments, the client 301 can provide a command for the system architecture 300 to the front end 310. The back end 320 can cause the command to be executed, using one or more of the processing device(s) 321, data structure(s) 340, and/or AI platform 330. In some embodiments, a standard query language (SQL) AI model 331 and/or a retrieval augmented generation (RAG) AI model 332 can generate outputs based on information provided by the back end 320. The outputs generated by one or more of the SQL AI model 330 and/or the RAG AI model 332 can be analyzed by the chatbot 322. The chatbot 322 can provide one or more recommendations to the client 301 based on the outputs from one or more of the SQL AI model 331 or the RAG AI model 332 that are received at the chatbot 322.

The back end 320 provides information and data to the front end 310 based on input from the client 301 and based on outputs of AI platform 330 and/or data retrieved from data structures 340. As described above, in some embodiments the front end 310 can interface with the back end 320 via one or more APIs. As used herein, “back end” can refer to a server-side portion of the system architecture 300 that is responsible for executing processes that are not visible to the client 301. The back end 320 allows the front end 310 to function effectively. The back end 320 can perform operations such as data processing, database management, user authentication, and the execution of application logic, system logic, and/or control logic. In some embodiments, the back end 320 can be an intermediary between the front end 310 and the data structures 340.

The back end 320 includes one or more processing devices 321 and a chatbot 322 in embodiments. The one or more processing devices can perform the operations of the back end 320, such as communicating with other components of the system architecture 300, processing data, or the like. In some embodiments, the chatbot 322, (also referred to herein as an “AI chatbot,” “AI model chatbot,” or “AI large language model (LLM)”) is enabled by the processing devices 321. That is, the software, code, or machine instructions for operating the chatbot 322 may be executed at the processing devices 321.

The chatbot 322 can be an AI model that is trained to receive input from the client 301 (e.g., via the front end 310) and provide respective responses to the input from the client 301 (e.g., via the front end 310). The chatbot 322 can leverage natural language processing (NLP) techniques, machine learning (ML) techniques, and/or deep learning (DL) techniques to simulate human-like conversational interactions (e.g., with inputs received from the client 301). The chatbot 322 can be trained or configured to understand the contents of a natural language input from the client 301 and perform one or more operations based the contents of the input. For example, the chatbot 322 can be configured (e.g., trained) to fulfil specific tasks, perform certain tests, answer queries (e.g., pre-determined queries, non-predetermined-determined queries, etc.), and/or engage in a dialogue with input received from the client 301.

In some embodiments, chatbot 322 is an ML-based chat model that uses natural language processing (NLP) techniques to understand and generate human language. This involves tasks, including tokenization (breaking down sentences into words or tokens), parsing (analyzing the grammatical structure of sentences), named entity recognition (identifying proper nouns, such as names of people, places, or organizations), and optionally sentiment analysis (determining the emotional tone of a conversation).

In some embodiments, the chatbot 322 can be implemented using a fine-tuned large language model (LLM). The chatbot 322 can be based on a purpose-built (e.g., purpose-trained) LLM that is designed to engage in some semblance of human dialogue with inputs received from the client 301. In some embodiments, the LLM used by the chatbot 322 can be a general-purpose LLM that is not finely tuned. In some embodiments, the LLM used by the chatbot 322 can be finely-tuned for use in the system architecture 300 specifically. In alternative embodiments, the LLM used by the chatbot 322 can be a general-purpose chatbot LLM.

In some embodiments, the chatbot 322 can interact with input received from the client 301 through, for example, intent recognition, entity extraction, and/or response generation. For example, the chatbot 322 can be trained to identify the “goal” or intent in a natural language input. In another example, the chatbot 322 can be trained to capture critical information from the natural language input. In another example, the chatbot 322 can be trained to leverage outside sources to obtain information that is relevant to the natural language input (e.g., the input from the client 301). In another example, the chatbot 322 can be trained to synthesize data that is extracted from the natural language input and data that has been collected in response to the natural language input into a response to the natural language input that can be presented to the client 301 via the GUI 312 of the front end 310. In some embodiments, the chatbot 322 can be trained to generate instructions (e.g., query instructions) based on the natural language input (e.g., a natural language query). The query instructions can include one or more processes or operations to be performed by the system architecture 300. For example, the query instructions can include generated computer code, scripts, or the like. In some embodiments, the chatbot 322 can use APIs to access information that is external to the data or processes used to execute the chatbot 322 (e.g., external to the back end 320). In the illustrative example, the chatbot 322 is enabled to use one or more APIs to access the AI platform 330 and/or the data structure 340. In some embodiments, the chatbot 322 can use these APIs directly. In alternative embodiments, the chatbot 322 can cause one or more processes of the back end 320 to use these APIs.

In some embodiments, the chatbot 322 can generate natural language responses to actions performed by the system architecture 300. For example, the system architecture 300 may cause one or more actions, such as tests, initializations and/or configurations, or the like, to be performed on the infrastructure 350. A visual representation of these actions and the results of these actions can be rendered in the GUI 312 via the front end 310 (e.g., the processing devices 311) for the client 301. The chatbot 322 can provide natural language commentary on the actions, the results, and/or visual renderings of the actions or results. For instance, the system architecture 300 (with or without instruction from the client 301) can perform a configuration operation on a group of network switches that have been added to the infrastructure 350. In an example, assume the configuration operation had a 90% success rate, as in 90% of the switches in the group of network switches were successfully configured. The front end 310 can render a visual representation of the 90% success rate, such as in a pie chart. The chatbot 322 can provide commentary on the 10% non-success rate, and may identify possible causes of the failure, potential next steps, or the like. To generate this natural language feedback or commentary, the chatbot 322 can receive the raw data input of the actions performed by the system architecture 300 and/or the results of the performed actions. In response, the chatbot 322 can generate the natural language commentary. In some embodiments, the chatbot 322 can further receive input such as the visual element that is rendered in the GUI 312 for the client 301 to generate the natural language commentary. In another example, once the results are provided to the client 301 via the front end 310, the chatbot 322 may receive input from the client 301 pertaining to the results, such as input requesting additional information, action recommendations, or potential identification of the cause of the provided results.

The back end 320 can leverage additional components of the system architecture 300, such as the AI platform 330 and/or the data structures 340 to perform one or more operations for the front end 310 (e.g., via one or more APIs). For example, the back end 320 can obtain information from one or more AI models of the AI platform 330. In another example, the back end 320 can obtain data from one or more of the data structures 340.

The AI platform 330 can include the structured query language (SQL) AI model 331 and/or the retrieval augmented generation (RAG) model 332. In some embodiments, the AI platform 330 is external to the system architecture 300 (not illustrated). That is, the AI platform 330 can be an external resource of the organization or entity hosting the system architecture, such as an external first party resource (e.g., an internal network attached resource) or external third party resource (e.g., a platform or service provided by a third party). The AI platform 330 can be a software platform or service provider that executes, or allows for the execution of, AI models on hardware resources. In some embodiments, the AI platform 330 can include AI-specialized hardware. That is, hardware that is specifically designed to execute common AI model operations.

The SQL AI model 331 can receive information from the back end 320 and generate one or more SQL commands for accessing data in the data structures 340. For example, the back end 320 can send information requesting access to a data item in the data structure 340 to the SQL AI model 331, and the SQL AI model 331 can provide the SQL instructions that allow the back end 320 to access the data item from the data structure 340. It can be appreciated that SQL is used here illustratively, and that in some embodiments, the SQL AI model 331 can generate other database language instruction sets and/or other structured queries which allow for querying, retrieving, inserting, updating, and/or deleting data in a database. In some embodiments, the SQL AI model 331 can receive some or all of a natural language input received from the client 301 (e.g., via the back end 320). The SQL AI model 331 can be trained to identify the data item(s) requested in the natural language input and generate appropriate database instructions (e.g., to access, modify, delete, etc., the date item(s)). The AI platform 330 can communicate the SQL instructions generated by the SQL AI model 331 to the back end 320. Responsive to receiving the SQL instructions, the back end 320 (e.g., the processing device(s) 321) can access the data item(s) from the data structures 340 (e.g., the infrastructure data 341).

The RAG AI model 332 can receive information from the back end 320 to generate one or more responses. For example, the RAG AI model 332 can receive information requesting hardware configuration information for a hardware component of the infrastructure 350, and can generate a response (e.g., based on RAG data 342) that includes the requested hardware configuration information. In some embodiments, the RAG AI model 332 can receive some or all of a natural language input received from the client 301 (e.g., via the back end 320). The RAG AI model 332 can be trained to identify, from the natural language input, what information has been requested and generate a response that includes the requested information. In some embodiments, the back end 320 can send some or all of the natural language input from the client 301 to the RAG AI model 332 with one or more text embeddings obtained from RAG data 342. That is, the back end 320 can be configured to perform the retrieval portion of the RAG operation prior to invoking the RAG AI model 332.

In some embodiments, the back end 320 can access the RAG data 342. RAG data 342 can include configuration information for components of the infrastructure 350 including user manuals, setup manual, device specifications, and the like. The back end 320 (e.g., via the processing devices 321 and/or the chatbot 322) can compute the similarity between the natural language input received from the client 301 and information stored in RAG data 342. For example, and in some embodiments, the back end 320 can convert the natural language input received from the client 301 into a text embedding and compare the text embedding input with text embeddings of the RAG data 342 stored in the data structures 340. The back end 320 can identify which RAG text embeddings satisfy a similarity criterion with the text embedding of the natural language input received from the client 301. The back end 320 can then send the RAG data 342 corresponding to the respective RAG text embeddings that satisfy the similarity criterion to the RAG AI model 332 along with the natural language input received from the client 301. In an alternative embodiment, the RAG AI model 332 or even the AI platform 330 may be connected to the data structures 340. The back end 320 can provide the RAG AI model 332 with the natural language input received from the client 301, and a preprocessing operation for the RAG AI model 332 can identify (e.g., using text embedding comparison as similarly described above) which portions of the RAG data 342 satisfy a similarity criterion with the natural language input received from the client 301. The RAG data 342 that satisfies the similarity criterion can then be used as a portion of the input to an LLM (e.g., the RAG AI model 332) to generate a response to the natural language input. For example, and in some embodiments, the RAG data 342 corresponding to the natural language input can be appended to the natural language input.

The back end 320 can retrieve information from the data structures 340. In some embodiments, the back end 320 can perform pre-determined data access operations to access, modify, and/or delete the infrastructure data 341 and/or RAG data 342. For example, component configuration data can be provided as input to the system architecture 300 by the client 301. The front end 310 may provide a user interface (e.g., GUI 312), such as a spreadsheet, document, form, or the like for the client 301 to provide data. In some embodiments, the front end 310 can receive file uploads from the client 301. For example, the system architecture 300 may receive comma separated value (CSV) files. Whether through manual input, file upload, or similar, the configuration data is received at the front end 310 and processed by the back end 320. The back end 320 stores the configuration information in the infrastructure data 341 with any appropriate data tags (e.g., as infrastructure data 341, RAG data 342, etc.). The data structures 340 can store secure information, such as user credentials, platform specific configurations, sensitive information, or the like. In some embodiments, this secure information can be stored in the infrastructure data 341, and may be connected to, or tagged with, a certain component, group of components, component vendor, or the like. In alternative embodiments, the data structures 340 can include a dedicated secure storage (not illustrated) that is configured using one or more of software, firmware, and/or hardware. For example, the data structures 340 can include a dedicated logical space (e.g., a partition) for storing secure information. In another example, the data structures 340 can include a dedicated physical component for storing secure information. In some embodiments, one or more hardware components of the data structures 340 may have enhanced security protections such as removable media controls, software and/or hardware encryption, storage logging, controlled data transfer mechanisms, hardware anti-tampering mechanisms, air gapped storage, or the like.

Infrastructure data 341 can include, for example, component identifiers (ID), internet protocol (IP) addresses, network information, network port mappings, physical locations, and the like pertaining to respective components of the infrastructure 350. For example, for a given network switch, the infrastructure data can include a device ID, an IP address assigned to the network switch (e.g., a static IP address), network information such as a media access control (MAC) address of the network switch, a list of port mappings for the network switch (e.g., a list of devices that are connected to each port of the network switch), a rack identifier, and a physical location of the rack within the data center. In some embodiments, the infrastructure data 341 can be used or accessed when a component of the infrastructure 350 fails and needs to be replaced, such as when requesting a return merchandise authorization (RMA) from a component vender. In some embodiments, a portion of RAG data 342 may also be used in a process to request an RMA from the vendor of a failed component.

In some embodiments, the front end 310 receives infrastructure data for a component or set of components of the infrastructure 350 from the client 301 (also referred to herein as “configuration data”). The back end 320 (e.g., the processing devices 321) can store the received configuration data as infrastructure data 341. In some embodiments, the back end 320 can identify (e.g., by the processing devices 321) that one or more portions of the received configuration data has already been stored as infrastructure data 341. For example, if the received configuration information includes data center administrator credentials, but data center administrator credentials are already stored in the infrastructure data 341, the back end 320 can identify the overlap. In some embodiments, the front end 310 may cause an alert to be displayed by the GUI when the back end 320 identifies an overlap. For example, the alert may indicate that what configuration information is overlapping (e.g., “These administrator credentials are a match for administrator credentials that have already been stored;” or the like). In another example, the alert may indicate whether the overlapping configuration information has been updated (e.g., “These administrator credentials do not match previously stored administrator credentials. The administrator credentials have been updated;” or “These administrator credentials do not match previously stored administrator credentials. The administrator credentials have not been updated;” or the like).

The front end 310 can receive device information such as a device specification, user manual, operating manual, or the like for components of the infrastructure 350 from the client 301. This device information can be stored as RAG data 342 in the data structure 340. For example, a file, such as a portable document format (PDF), containing the device information can be received from the client 301 at the front end 310 and stored in data structures 340 by the back end 320 as RAG data 342. In some embodiments, the back end 320 can extract information from the received device information file and store the extracted information as raw data or plain text in the data structure 340 (e.g., as the RAG data 342). Alternatively in some embodiments, as described, the file (such as the PDF) is stored as RAG data 342. In some embodiments, the back end 320 converts the device information into a compressed data type, such as one or more text embedding. In such embodiments, the back end 320 stores the compressed data type (e.g., the text embeddings) as the RAG data 342. Alternatively in some embodiments, the text embeddings (or similar data type used to perform a comparison operation during the retrieval portion of RAG) can be computed by the back end 320 from the files stored as RAG data 342 (e.g., PDF files, document files, etc.) each time the back end 320 receives a new natural language input from the client 301.

In some embodiments, once a compressed data type (e.g., text embedding) is generated, it can be stored in the data structures 340 for future use. In such embodiments, the back end 320 can receive the natural language input from the client 301 and determine whether a compressed data type has been generated for a portion of the RAG data 342. Responsive to determining the compressed data type has not been generated for the portion of the RAG data 342, the back end 320 can generate and store the respective compressed data type. Alternatively, responsive to determining the compressed data type has been generated for the portion of the RAG data 342, the back end 320 can use the previously-generated compressed data type for the portion of the RAG data 342 to perform a portion of the retrieval portion of the RAG operation. In some embodiments (not illustrated) the AI platform 330 can perform one or more functions that are described herein as being performed by the back end 320. For example, the AI platform 330 may access the RAG data 342 directly, and/or may generate compressed data types (e.g., text embeddings) for device information to be stored as RAG data 342. In another example and in some embodiments, the back end 320 can send the device information to the AI platform 330 which can compute the compressed data equivalent (e.g., a text embedding), and send the compressed data equivalent to the back end 320. The back end 320 can store the compressed data equivalent in the data structure 340 as RAG data 342. In some embodiments, the back end 320 can similarly perform one or more functions that have been described herein as being performed by the AI platform 330.

The infrastructure 350 can include network devices such as servers, switches, data processing units (DPUs), and the like as described throughout this application. In some embodiments, the infrastructure 350 is not complete. That is, the system architecture 300 can be used on an incomplete, or partially completed infrastructure 350. For example, when building, connecting, initializing, and/or configuring various components of the infrastructure 350, some or all components may be built/installed, connected, initialized and/or configured individually or piece by piece until all components of infrastructure 350 for the data center are configured. In such embodiments, the system architecture 300 can provide instructions to the client 301 for building/installing, connecting, initializing, and/or configuring one or more components of the infrastructure 350 during a data center deployment.

The client 301 can also use the system architecture 300 to perform tests, such as connectivity tests, validation checks, or the like on one or more portions of the infrastructure 350. The back end 320 can access one or more components of the infrastructure 350, for example using an API to perform these various tests. The system architecture 300 can perform various tests on the infrastructure 350, including predefined tests, and non-predefined or customizable tests.

One or more examples of predefined tests can include, for example, an intelligent platform management interface (IPMI) check, an inband check, an environment check, a port check, a bond check, a virtual local area network (VLAN) check, a route check, a border gateway protocol (BGP) check, a virtual extensible LAN (VXLAN) with ethernet virtual private network (EVPN) check or the like. As used herein, an “IPMI check” can be used to verify the health and responsiveness of an IPMI interface, such as by “pinging” the server hardware that implements the IPMI interface. As used herein, an “inband check” can send ICMP “ping” packets between various networking components or devices to verify responsiveness of target networking components. As used herein an “environment check” can collect or report the status of various environmental sensors attached to or in close physical proximity to a network device, including temperature, moisture, humidity, fan speed, power, etc. As used herein a “port check” can verify the availability and/or status of a specific network port or group of network ports (e.g., transmission control protocol (TCP) or user datagram protocol (UDP) ports). As used herein a “bond check” can determine whether bonded network interfaces (e.g., link aggregation) are active and configured to provide redundancy in the event of a single failure. As used herein, a “VLAN check” refers to validating that a given virtual LAN has been properly configured for proper tagging, inter-VLAN communication, and isolation from other VLANs. As used herein a “route check” verifies the existence and correctness of one or more network routes (either pre-configured or automatically determined by networking devices of the infrastructure 350) to determine whether network traffic flows as expected from points of origin to intended destinations. As used herein, a “BGP check” can verify that networking routes are properly advertised, peer connectivity is as expected, and the routing table for a given network is consistent. As used herein, a “VXLAN EVPN” check encapsulates layer 2 ethernet frames within UDP/IP and can extend the 12-bit VLAN ID to a 24-bit VXLAN Network Identifier (VNI). VXLAN can use VXLAN tunnel endpoints (VTEPs) to encapsulate and decapsulate traffic at the network edge. This is paired with EVPN, which is a multi-protocol BGP (MP-BGP) control plane that advertises layer 2 and layer 3 reachability information. EVPN enables MAC address learning in the control plane and supports multi-homing. Together, the VXLAN EVPN check can confirm the functionality of layer 2 and layer 3 extensions, network redundancy, and load balancing operations under each protocol are functioning. In some embodiments, the actual functions (e.g., tested functions) of the system architecture 300 with respect to any of the above tests can be compared to the single source of truth for each respective test (e.g., the designed functions).

In some embodiments, further examples of predefined tests can include software and/or firmware checks, where a software and/or firmware version of a component of the infrastructure (e.g., a network switch such as an Nvidia Link (NVLink) switch (NVSwitch)) is verified. Another example of a predefined test includes a health assessment of NVLinks between components of the infrastructure 350 (e.g., between NVSwitches of the infrastructure 350, etc.). Another example of a predefined test includes a test to confirm that zero-touch provisioning has been executed successfully. As used herein, “zero-touch provisioning” (ZTP) can refer to a configuration of NVSwitches. Zero-Touch Provisioning can automate the initial configuration of switch systems at boot time. It can help minimize manual operation and facilitate datacenter deployment (e.g., as the infrastructure 350). ZTP allows for automatic upgrade of the switch with a specified OS image, setting up the initial configuration database, and to load and run a container from an image file. ZTP is based on DHCP and is enabled by default on ZTP-configured devices, such as NVSwitches. For ZTP to work, the software enables DHCP by default on all its management interfaces. Another example of a predefined test includes a test to validate specific components (e.g., hard ware) of the infrastructure 350. For example, the system architecture can cause one or more hardware components of the infrastructure 350 to be validated, including graphics processing units (GPUs), central processing units (CPUs), or the like.

One or more examples of non-predefined or customizable tests that the system architecture 300 can perform on the infrastructure 350 includes commands entered into a network terminal, modifications of one or more of the predefined tests, or the like.

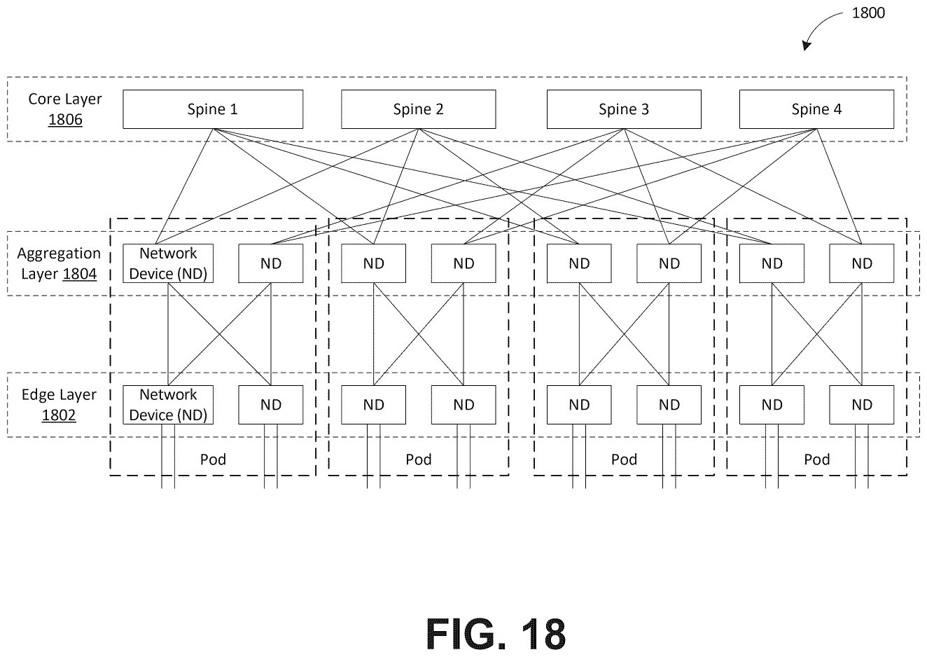

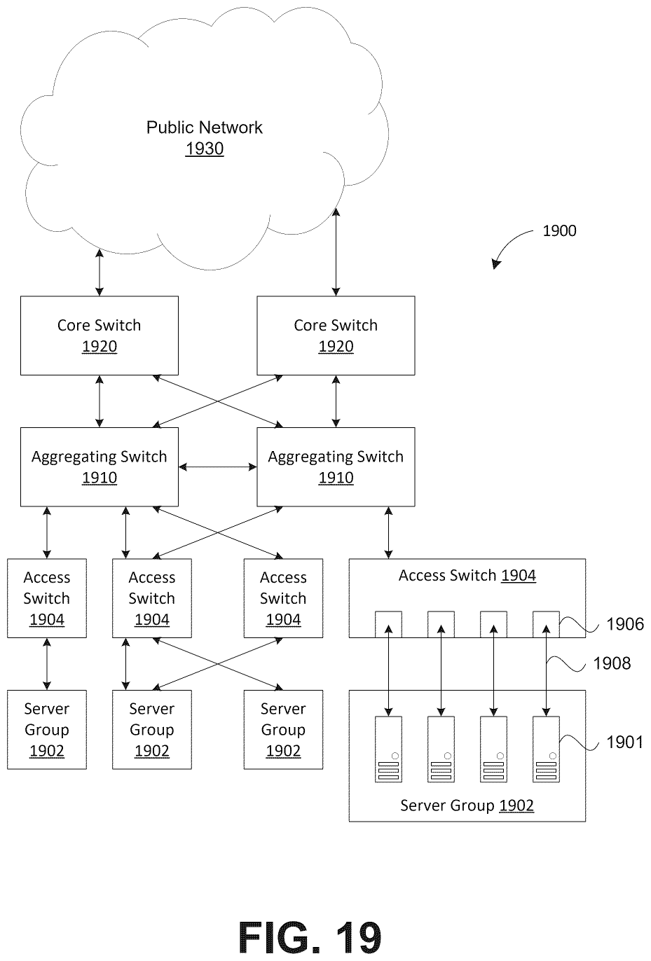

Another test that may be performed by the system architecture 300 on the infrastructure 350 is an automated cable verification. The automated cable verification test is used to verify the physical connections between components of the infrastructure 350, including that cables are routed between the proper ports, that cables are properly seated in ports of a component, and the like. In some embodiments, the infrastructure 350 (e.g., via the front end 310) can generate and/or visually render a virtual representation of physical cable connections between various components of the infrastructure 350, which can reduce the need to perform physical inspections of the hardware cabling. In some embodiments, the automated cable verification tool can cause a table including point-to-point connections between devices to be maintained (e.g., such as connections between devices as illustrated below with reference to FIGS. 18-19). In some embodiments, when the test is performed, the system architecture 300, via for example, the processing device(s) 321, queries network devices of the infrastructure 350 to collect all active point-to-point connections. In some embodiments, the point-to-point connections can include neighbor device and port details. In some embodiments, the point-to-point and neighbor device details can be obtained via link layer discovery protocol (LLDP). After the active point-to-point connections are obtained, the cable verification test can cause the active point-to-point connections to be compared against the table storing the point-to-point connections. For each connection, the test can indicate a pass/fail, where a pass indicates a match between the active point-to-point connection, and a fail indicates a mismatch between the active point-to-point connection. For example, an active point-to-point connection can indicate port 1 is connected to port 4. If the table indicates that port 1 is to connect to port 4, it is a “pass.” However, if the table indicates that port is to connect to port 3, it would be a “fail.”

In some embodiments, the back end 320 accesses log data for one or more components of the infrastructure 350 to perform tests. The back end 320 can access the log data for a component via an API for the component. In some embodiments, the information that is provided in response to an API call to the component of the infrastructure 350 is received at the back end 320 in a proprietary data type, or in a custom presentation or data organization. That is, the formatting of the relevant data may be specific to the component, a family of components, a brand, or the like. As such, the information received by the back end 320 from some components of the infrastructure 350 may not be interoperable with information received from other components of the infrastructure 350 in raw data, or received data formats. In some embodiments, the relevant information can be extracted from the received infrastructure information using custom-written scripts. In such embodiments, a script is written for each component type, component group, brand, or the like so that data can be extracted from the information returned via API call to the back end 320. In alternative embodiments, the back end 320 can implement an AI model that processes the received infrastructure information. The AI model can be trained to extract the relevant information from each received data log and discard non-relevant information. For example, the AI model can be trained to extract a port name, and discard header information identifying a manufacturer of the network device. In another example, the AI model can be trained to extract a certain data type from a data formatting scheme and save the certain data type in a data formatting scheme that is universal to the system architecture. In some embodiments, the LLM used by the chatbot 322 can be trained to perform this function. In alternative embodiments, another AI model (not illustrated) can be trained to extract data from received log files. In some embodiments, the extracted data can be saved as infrastructure data 341. In some embodiments, the extracted data is used by the front end 310 to render one or more visual representations or indications of the network health of the infrastructure 350 via the GUI 312 to the client 301.

When a request to perform a network test is received at the front end 310 from the client 301, the back end 320 can obtain information from the applicable components of the infrastructure 350 in real-time. As used herein, “in real time” can refer to a near-instantaneous processing, transmission, or response to data or events as they occur, without noticeable delay. “In real time” further refers to systems or processes that are capable of handling information continuously and synchronously, ensuring outputs are delivered or actions are taken with minimal latency relative to the input or event. That is, in the illustrative FIG. 3, the back end 320 can request information from each component in response to the request from the client 301. Log data can be received from a component of the infrastructure 350 and relevant information can be extracted and visually rendered for the client 301, as described above.

In some embodiments, the infrastructure data 341 can include three-dimensional (3D) location data for components of the infrastructure 350. For example, the infrastructure data 341 may include a 3D representation of the data center, or portions of the data center. When a component of the infrastructure is selected by the client 301 or otherwise presented via the GUI 312, the back end 320 can provide the 3D location data to the front end 310. The front end 310 can use the 3D location data to render 3D animations, 2D images, and the like. For example, the front end 310 may render a static 2D image of the front of a rack with the particular network device highlighted. In another example, the front end 310 may render a 2D top-down view of the data center with a particular rack or set of racks highlighted. Other such 2D or 3D renderings are considered, including 2D or 3D renderings via wearable devices such as smart glasses in virtual reality (VR), mixed reality (MR), and/or augmented reality (AR).

In some embodiments, one or more components of the infrastructure 350 can be initialized and/or configured by the system architecture 300. In some embodiments, the initialization and/or configuration can be performed using one or more of information stored in the infrastructure data 341, and/or information received from the client 301 via the front end 310. In some embodiments, the system architecture 300 can be used to initialize and/or configure one or many components of the infrastructure 350. For example, the system architecture 300 can assign a static IP address to a particular network switch. In another example, the system architecture 300 can map 100,000 MAC addresses to interface names, VLANs, and corresponding network switches. That is, the system architecture 300 (e.g., via the processing device(s) 321) can provision network and server devices, including performing firmware and software checks and upgrades, and software configuration pushes. In some embodiments, this initialization and/or configuration of components of the infrastructure 350 can be automated or partially automated, as is described in the following examples. In some embodiments, the status or connectivity of one or more components of the infrastructure 350 can be verified by the system architecture 300 (e.g., via the front end 310, and/or the chatbot 322). For example, the system architecture 300 can identify in real-time which components have been installed, initialized, and/or configured in the infrastructure 350, and which components have not yet been installed, initialized and/or configured. In some embodiments, once the provisioning is complete, the system architecture 300 (e.g., via the processing device(s) 321) can initiate health checks to validate the status of the network devices and/or server devices and retrieve relevant information from the network and/or server devices (e.g., connectivity information). Once collected, the status and/or relevant information from the network and/or server devices can be compared to corresponding data (e.g., stored in a memory of the back end 320). In some embodiments, the chatbot 322 can perform this function by referencing data that is stored in the infrastructure data 341 and/or the RAG data 342, including serial numbers for particular components and/or specifications for the particular components. For example, using the chatbot 322, the client 301 can confirm whether the 100,000 MAC addresses of end hosts (e.g., servers) are correctly mapped to network devices with the proper (e.g., designed or targeted) network settings.

In a first example of initialization and/or configuration of components in the infrastructure 350 and in some embodiments, when the component is installed and/or connected to the infrastructure 350, initialization and/or configuration information stored in the infrastructure data 341 can be used to (i) initialize and configure the component, and/or (ii) configure one or more connections between the component and other components of the infrastructure 350. In some embodiments, the system architecture 300 (e.g., via the back end 320) can detect that a particular component has been added to the infrastructure 350 and in response, use the configuration information stored in the infrastructure data 341 to initialize and/or configure the particular component. In some embodiments, if an error occurs during this responsive initialization and/or configuration, the system architecture 300 (e.g., via the front end 310) can prompt the client 301 for instructions.

In a second example of initialization and/or configuration of components in the infrastructure 350 and some embodiments, when a particular component is added to the infrastructure 350, the system architecture 300 can detect the particular component and generate a notification for the client 301, such as a visual notification to be rendered in the GUI 312. The notification for the client 301 may provide one or more options to initialize and/or configure the particular component. For instance, a first option may be to perform the initialization and/or configuration based on stored component information (e.g., in the infrastructure data 341). In another instance, a second option may be to proceed with a manual initialization and/or configuration as led by one or more inputs via the client 301.

In a third example of initialization and/or configuration of components in the infrastructure 350 and some embodiments, the front end 310 can provide the client 301 with an interface in the GUI 312 (such as GUIs 400A-E, described below). The front end 310 can be configured to receive instructions from the client 301 to perform an initialization and/or configuration of a component of the infrastructure 350. In some embodiments, the system architecture 300 can respond to these instructions from the client 301 by using initialization and/or configuration information that is stored in infrastructure data 341.

In some embodiments, the GUI 312 can be an Nvidia NMX management interface. In some embodiments, the system architecture 300 can interface with an NMX telemetry sub-system that collects, aggregates, and transmits telemetry data from various components of the infrastructure 350. In some embodiments, one or more operations performed at the back end 320 and/or the front end 310 can verify the operations of the NMX telemetry sub-system.

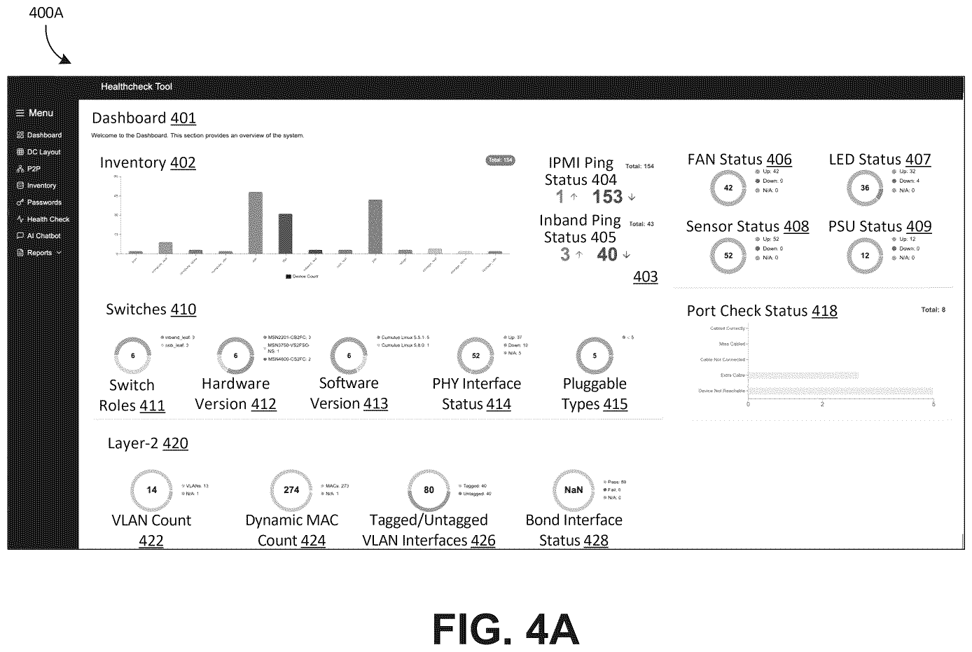

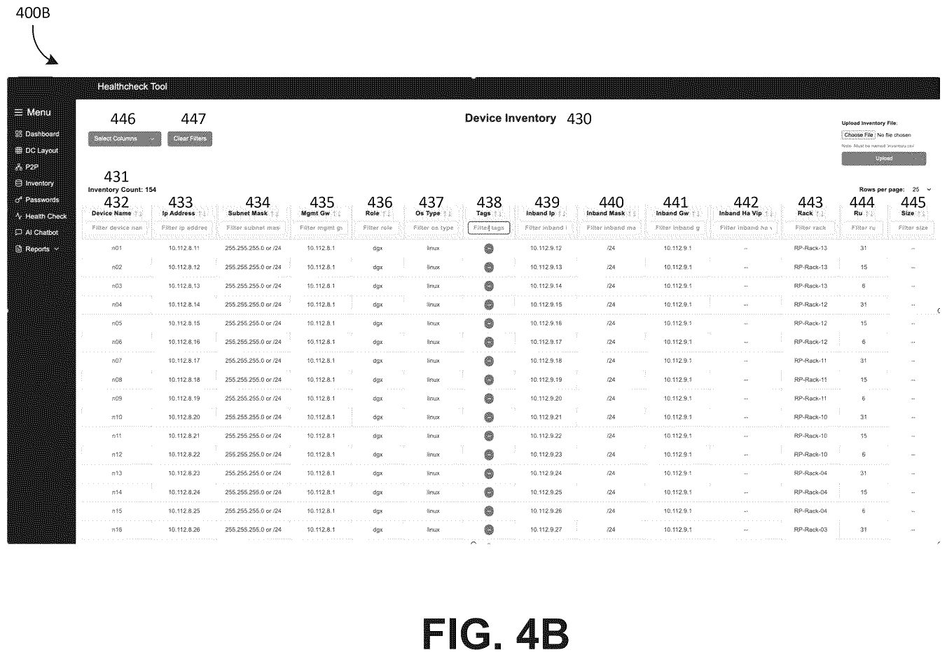

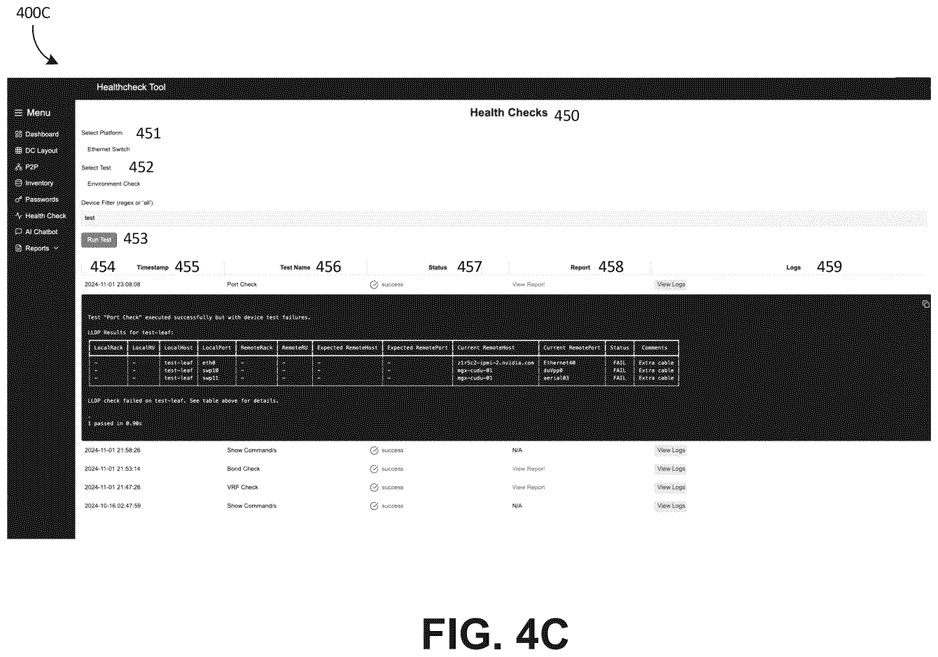

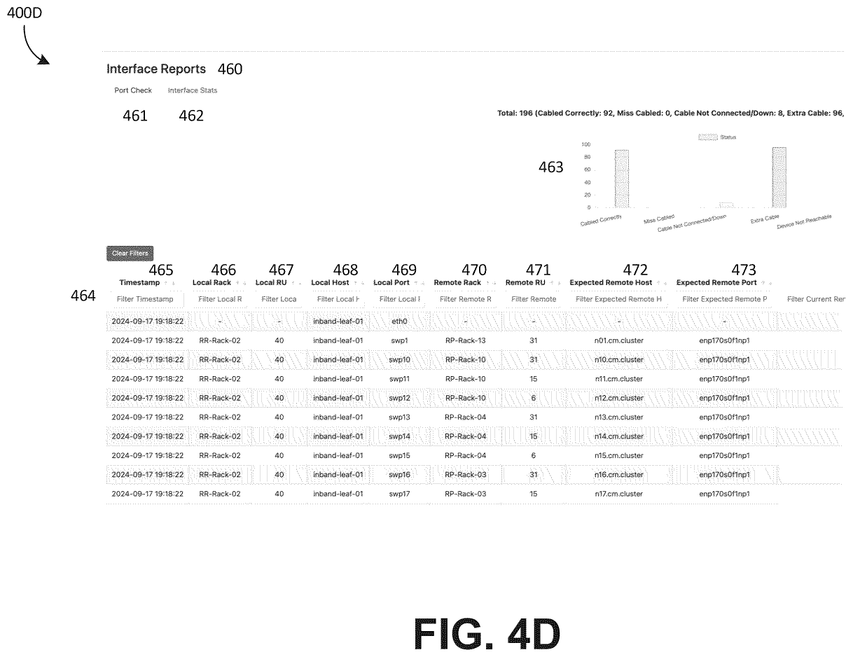

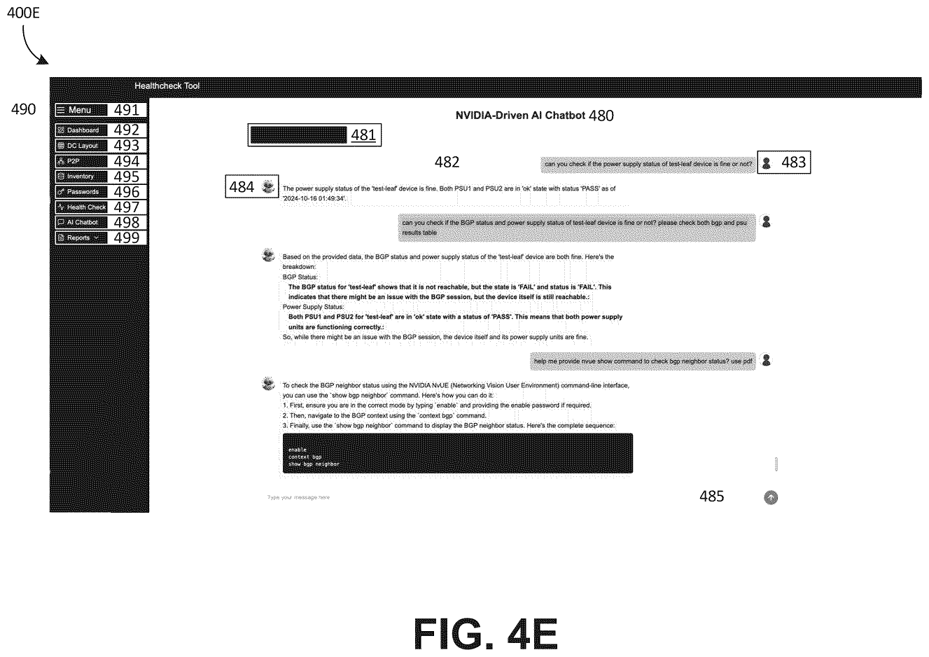

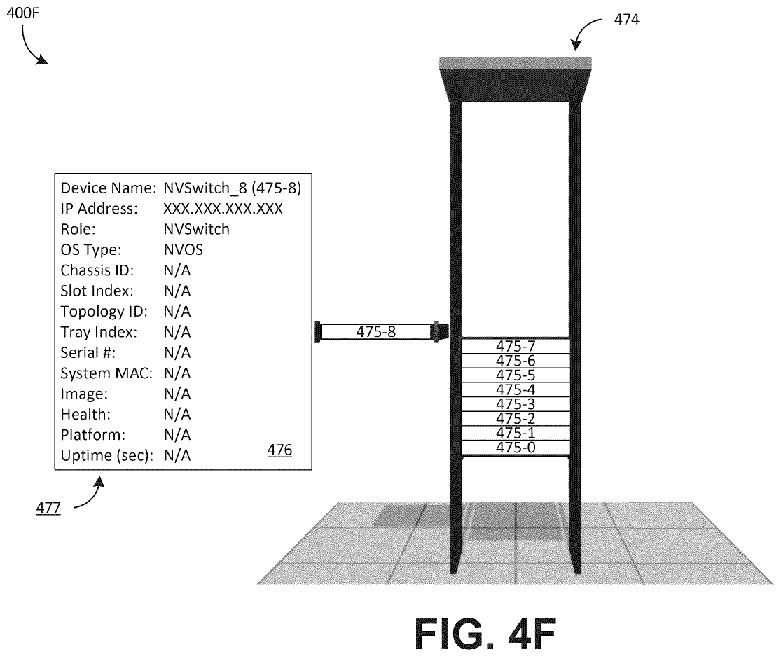

FIG. 4A is an example graphical user interface (GUI) 400A that renders a visual representation of a network health of a data center deployment via a client device, according to some aspects of the disclosure.

The GUI 400A includes a dashboard 401 which displays network health information at a glance. The dashboard 401 includes distinct graphical elements for inventory 402, ping status 403, environmental data, switches 410, port status 418, and layer-2 420.

The inventory 402 shows a list of network devices of a data center (e.g., the infrastructure of a data center, such as infrastructure 350 of FIG. 3). Each device type is shown as a distinct bar in a bar graph, where the height of the bar corresponds to the number of devices of that device type in the data center (or currently deployed if the data center deployment has not concluded).

The ping status 403 displays an IPMI ping status 404 and an inband ping status 405. Both ping statuses display a best case (on the left) and a worst case (on the right) for a given time frame or number of pings (here 154 IPMI pings, and 43 inband pings).

The environmental data displays a fan status 406 of system fans in the data center, a light emitting diode (LED) status 407, a sensor status 408, and a power supply unit (PSU) status 409.

The switches 410 graphical element displays switch roles 411, switch hardware version 412, switch software version 413, physical (PHY) interface status 414, and pluggable type 415.

Port status 418 displays a physical connection status of a network device or group of network devices.

Layer-2 420 displays a VLAN count 422, a dynamic MAC count 424, a tagged/untagged VLAN interface status 426, and a bond interface status 428.

FIG. 4B is an example graphical user interface (GUI) 400B that renders a visual representation of a network health via a client device, according to some aspects of the disclosure.

The GUI 400B is primarily textual, displaying a table for a group of network devices (e.g., a device inventory table 430). An inventory count 431 is displayed with the device inventory table 430. The columns of the device inventory table 430 include: device name 432, IP address 433, subnet mask 434, management gateway 435, role 436, operating system (OS) type 437, tags 438, inband IP address 439, inband mask 440, inband gateway 441, inband high-availability (HA) virtual IP (VIP) 442, rack number 443, rack unit (RU) number 444, and size 445. As illustrated, not every column will have information for each network device in the data center. Additionally, the illustrated columns are exemplary, and some columns may be excluded, or additional columns may be considered. The GUI 400B includes a column selector tool 446 (e.g., a drop down menu) to visually display or hide certain columns. The GUI 400B also includes a clear filter selector 447 for clearing any filters or selections made in the device inventory table 430 (e.g., as illustrated in the filter or selection box at the top of each of the columns of the device inventory table 430).

FIG. 4C is an example graphical user interface (GUI) 400C that renders a visual representation of a network health via a client device, according to some aspects of the disclosure.

The GUI 400C is an interface for performing network health checks on a data center during a data center deployment. The GUI 400C includes the health checks element 450. The health checks element 450 includes drop down menus for platform selection 451 and test selection 452. Once a test and platform is selected (e.g., using platform selection 451 and test selection 452), the run test button 453 can be selected to run the selected test on the selected platform. The test table 454 displays the results of the selected test. The columns of the test table include timestamp 455, test name 456, status 457, report 458, and logs 459. The text interface (the black terminal and white text) is displayed in response to selecting the “view report” option in the report 458 column.

FIG. 4D is an example graphical user interface (GUI) 400D that renders a visual representation of a network health via a client device, according to some aspects of the disclosure.

The GUI 400D includes an interface report 460. The interface report 460 has two options tabs, port check 461 and interface stats 462.

The port check 461 includes a cable connection status graphical representation 463 and a report table 464. The columns of the report table 464 include a timestamp 465, a local rack identifier 466, a local rack unit identifier 467, a local host identifier 468, a local port 469, a remote rack identifier 470, a remote rack unit identifier 471, an expected remote host 472, and an expected remote port 473.

FIG. 4E is an example graphical user interface (GUI) 400E that renders a visual representation of a chatbot via a client device, according to some aspects of the disclosure.

The GUI 400E includes a chatbot element 480 and standard fields 490 (which are present in the one or more preceding GUIs 400A-400D). The chatbot element 480 includes a delete chat visual element 481 and a chat box 482. The chat box 482 includes graphical representations for a user 483 and the chatbot 484. The illustrative GUI 400E illustrates an example conversation between the user 483 and the chatbot 484, which each party engaging in a back-and-forth dialogue. The chat box 482 further includes the input box 485, where the user 483 can provide input that may be processed by the chatbot 484.

The standard fields 490 include a menu element 491, a dashboard element 492, a data center layout element 493, a peer-to-peer (P2P) element 494, an inventory element 495, a credentials element 496, a health check element 497, an AI chatbot element 498, and reports element 499. Each of the standard field elements can be selected to cause the corresponding graphical element to be displayed. For example, the dashboard element 492 may be selected to display the GUI 400A of FIG. 4A. In another example, the AI chatbot element 498 may be selected to display the GUI 400E, and the like.

FIG. 4F is an example graphical user interface (GUI) 400F that renders a visual representation of a server rack, according to some aspects of the disclosure. The GUI 400F includes a graphical representation of a server rack 474. The server rack includes multiple components, such as switch(es) 475 (illustrated here as switches 475-0, 475-1, 475-2, 475-3, 475-4, 475-5, 475-6, 475-7, 475-8). The server rack 474 can include other computing components, such as servers, top level switches, computing devices, other networking components, or the like.

The GUI 400F can allow for the selection of a component of the server rack 474. As illustrated, switch 475-8 has been selected. In some embodiments, the component of the server rack 474 can be visually separated from the server rack 474, as is illustrated by the switch 475-8.

When a particular component of the server rack 474 is selected, configuration information 477 can be displayed in a graphical element 476 (e.g., a “window”). The configuration information 477 illustrated in FIG. 4F for the GUI 400F is illustrative, and represents potential configuration information that may be displayed in the graphical element 476. In some embodiments, results from tests performed (as described above with reference to FIG. 3) can be displayed in the graphical element 476 for a particular selected component of the server rack 474. In some embodiments, the GUI 400F can render a 2D, 3D, VR, AR, or the like representation of a corresponding physical server rack, as described above with reference to FIG. 3.

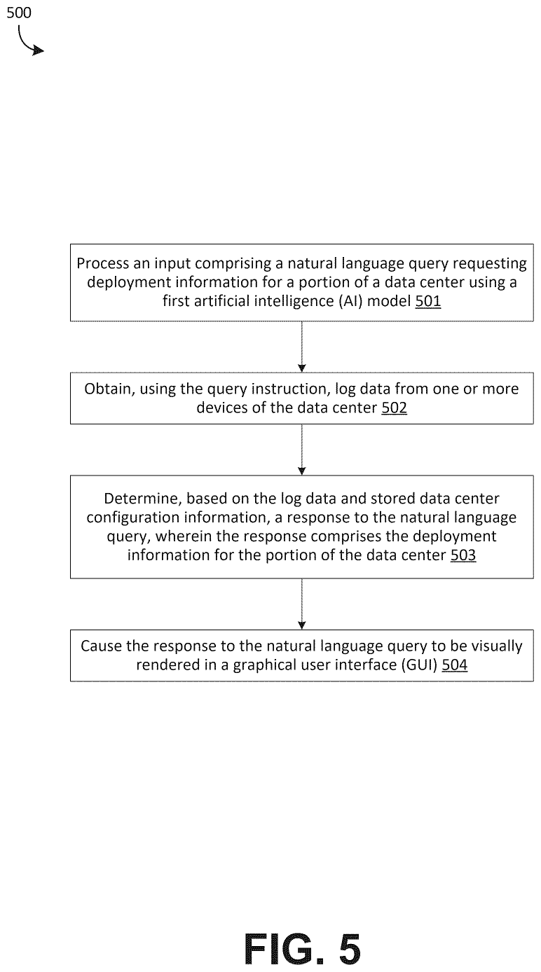

FIG. 5 is a flow diagram of an example method 500 for performing a network health check using a system architecture, according to some aspects of the disclosure. The method 500 can be performed by control logic that may include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the network device 104, 112 of FIG. 1. In some embodiments, the method 600 is performed in whole or in part by the client 301 or the system architecture 300 of FIG. 3. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 501, the control logic performing the method 500 processes an input including a natural language query requesting deployment information for a portion of a data center using a first artificial intelligence (AI) model. The first AI model can be trained to output a query instruction based on the natural language query. In some embodiments, the query instruction is a structured query language (SQL) instruction. In some embodiments, the query instruction is formatted in another database manipulation programming language or instruction set. In some embodiments, the input can include one or more natural language queries.

In some embodiments, some or all of the operation 501 can be performed at the AI platform 330 of FIG. 3 by the SQL AI model 331. In some embodiments, the input at the SQL AI model 331 is received from the client 301. The SQL AI model 331 may generate the SQL instruction based on the input received from the client 301.

In alternative embodiments, a portion of the operation 501 may be performed at the back end 320 of FIG. 3 by the chatbot 322. A natural language query may be received at the front end 310 from the client 301 and processed by the chatbot 322.

In some embodiments, the input at the SQL AI model 331 is received from the chatbot 322. For example, and in some embodiments, the client 301 can provide a natural language query to the front end 310, which is processed by the chatbot 322. The chatbot 322 can provide a portion of the natural language query to the SQL AI model 331 as an input.

In some embodiments, a portion of the operation 501 is performed at the back end 320 of FIG. 3 by the chatbot 322. In some embodiments, the input at the SQL AI model 331 is received from the chatbot 322. The client can then provide a natural language query to the front end 310. The chatbot 322 can process the natural language query and generate an input for the SQL AI model 331 based on the natural language query received from the client 301 in embodiments.

At operation 502, the control logic obtains, using the query instruction, first log data from one or more devices of the data center. In some embodiments, some or all of the operation 502 can be performed at the AI platform 330 of FIG. 3 by the SQL AI model 331. Log data can include information about events and activities that is generated during the operation of a device. For example, log data can include timestamped entries that document system processes, configuration changes, data flows, and specific events such as errors. Log data can also include details such as IP addresses, protocols used, networking port identifiers, networking port utilization values, and the like.

At operation 503, the control logic determines, based on the log data and stored data center configuration information, a response to the natural language query. The response includes the deployment information for the portion of the data center. In some embodiments, the stored data center configuration information is a single source of truth (SSOT). The single source of truth can be assembled by combining multiple files or documents into a single repository. In some embodiments, the single source of truth is generated from an uploaded file, such as a comma separated values (CSV) file. In some embodiments, the single source of truth includes one or more of device information, port connection information, physical location information, or network configuration information.

In some embodiments, to determine the response to the natural language query, the control logic can process the first log data using a second AI model. The second AI model can be trained to extract telemetry data from log data. The second AI model can output first telemetry data based on the first log data. In some embodiments, the second AI model can generate one or more scripts that, when executed, cause the telemetry data to be extracted from the log data.

The control logic can compare telemetry data from the retrieved log data to the data center configuration information to determine whether the data center has been deployed correctly and/or whether one or more components of the data center are operating within specified operating parameters. For example, control logic may determine whether a first portion of the telemetry data matches a first portion of the stored data center configuration data. Based on a result of comparing the log data to the data center configuration data, control logic may generate a response to the natural language query. For example, if the first portion of the telemetry data matches a first portion of the stored data center configuration data, the control logic can generate a response to the natural language query that indicates that a first portion of the data center has been properly configured. In another example, if the first portion of the telemetry data does not match the first portion of the stored data center configuration data, the control logic can generate a response to the natural language query that indicates that a first portion of the data center has not been properly configured. In some embodiments, if the first portion of the telemetry data does not match the first portion of the stored data center configuration data, the control logic can generate a response to the natural language query that describes what has been properly configured and what has not been properly configured. In some embodiments, the response can include additional information and/or requests. For example, the response can include troubleshooting steps that can indicate how to properly configure the data center.

At operation 504, the control logic causes the response to the natural language query to be visually rendered in a graphical user interface (GUI), such as the GUI 312 of FIG. 3. In some embodiments, a visual representation of the portion of the data center is visually rendered in the GUI, based on the deployment information. For example, a network device, a rack, a rack unit, or the like may be rendered in a 2D or 3D representation. In some embodiments, some or all of the operation 504 can be performed at the front end 310 of FIG. 3.

In some embodiments, the control logic further determines that the natural language query is requesting device information for a first device of the data center. The control logic can perform a retrieval augmented generation (RAG) operation on the stored data center configuration information to obtain first device information. The stored data center configuration information includes a corpus of information for devices of the data center. The response generated by the first AI model is further based on the first device information obtained using the RAG operation.

In some embodiments, the control logic receives first data center configuration information (e.g., via a data entry application, such as the front end 310 of FIG. 3). The control logic further receives second data center configuration information. In some embodiments, the first data center configuration information and the second data center configuration information each pertain to different components of the data center. The control logic can generate a portion of the stored data center configuration information based on the first data center configuration data and the second data center configuration data. In some embodiments, the control logic can cause a GUI element to be visually rendered. The GUI element can include one or more first data entry fields for the first configuration data and one or more second entry fields for the second configuration data. For example, the GUI element can include one or more cells arranged as a table resembling a spreadsheet.

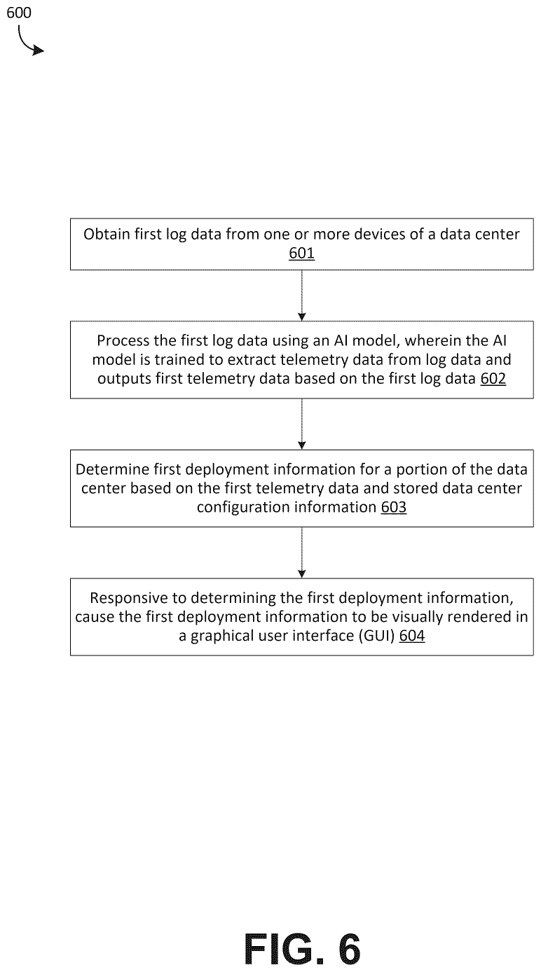

FIG. 6 is a flow diagram of an example method 600 for system architecture for network health check, according to some aspects of the disclosure. The method 600 can be performed by control logic that may include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the network device 104, 112 of FIG. 1. In some embodiments, the method 600 is performed in whole or in part by the client 301 or the system architecture 300 of FIG. 3. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 601, the control logic performing the method 600 obtains first log data from one or more devices of a data center. In some embodiments, the log data from each device can have a particular formatting. For example, log data from a first device may have a first formatting, log data from a second device may have a second formatting, etc. As described above, log data can include timestamped entries that document system processes, configuration changes, data flows, specific events (e.g., errors), IP addresses, protocols used, networking port identifiers, networking port utilization values, and the like. In some embodiments, some or all of the operation 601 can be performed at the back end 320, such as by the processing device(s) 321.

At operation 602, the control logic processes the first log data using an AI model. The AI model is trained to extract telemetry data from the log data. The AI model outputs first telemetry data based on the first log data. The AI model can be trained to identify specific telemetry data from log data in a variety of log data formats (e.g., including in the first format or second format described above). In some embodiments, some or all of the operation 602 can be performed at the AI platform 330 by the SQL AI model 331. In alternative embodiments, some or all of the operation 601 can be performed at the back end 320, such as by the chatbot 322 and/or processing device(s) 321. In some embodiments, the telemetry data can be stored as infrastructure data 341. In some embodiments, the SQL AI model 331 of the AI platform 330 can receive the natural language input query from the client 301 and generate SQL instructions to obtain telemetry data from the infrastructure data 341. In some embodiments, the chatbot 322 can receive the natural language query and generate an input for the SQL AI model 331 based on the natural language query.

At operation 603, the control logic determines first deployment information for a portion of the data center based on the first telemetry data and stored data center configuration information. In some embodiments, some or all of the operation 603 is performed by the processing device(s) 321 of the back end 320. The processing device(s) 321 can compare stored data center configuration information (e.g., in the infrastructure data 341) with telemetry data obtained in the operations 601-602. In some embodiments, the telemetry data can be stored as a portion of the infrastructure data 341.

At operation 604, responsive to determining the first deployment information, the control logic causes the first deployment information to be visually rendered in a graphical user interface (GUI). The first deployment information can indicate, for example, whether the data center has been properly deployed is functioning as intended (e.g., whether the queried telemetry data matches the saved configuration data). In some embodiments, the first deployment information can indicate one or more non-functioning or improperly deployed portions of the data center. In some embodiments, the first deployment information can indicate one or more steps to remedy the non-functioning or improperly deployed portions of the data center. For example, the first deployment information can indicate that port A of device I is not properly connected to port B of device II, and that a step to remedy the issue would be to connect port A of device I to port B of device II by a communications cable.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs), one or more small language models (SLMs), one or more vision language models (VLMs), and/or one or more multimodal language models (MMLMs), systems for performing light transport simulation, systems for performing collaborative content creation for 3D assets, systems implemented at least partially using cloud computing resources, and/or other types of systems.

### Computer Systems

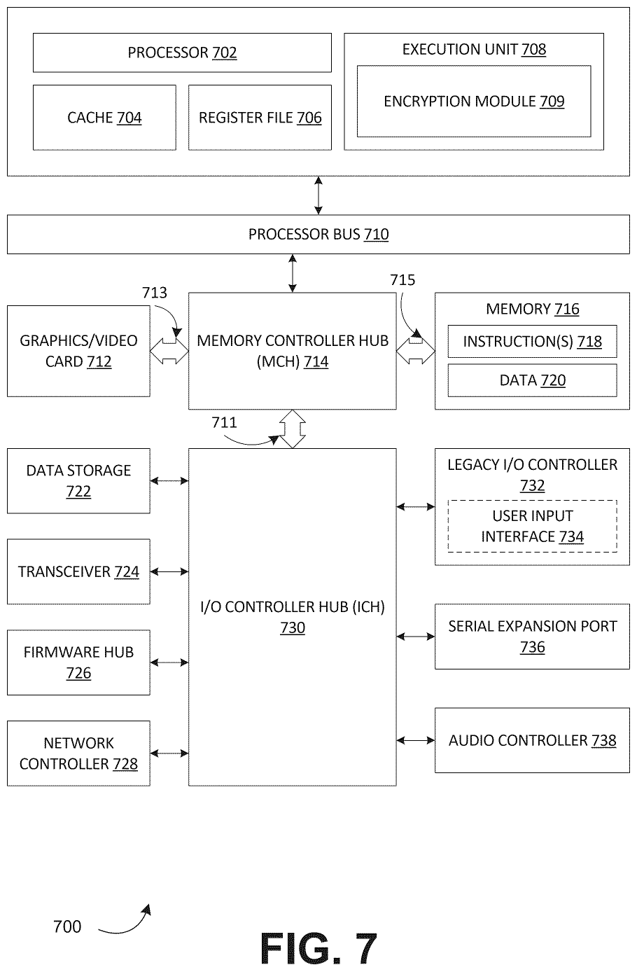

FIG. 7 is a block diagram illustrating an exemplary computer system, such as computer system 700, which can be a system with interconnected devices and components, a system-on-a-chip (SOC), or some combination thereof, according to some aspects of the disclosure. In some embodiments, computer system 700 can include, without limitation, a component, such as a processor 702, to employ execution units including logic to perform algorithms for process data, in accordance with the present disclosure, such as in the embodiments described herein. In some embodiments, computer system 700 can include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) can also be used. In some embodiments, computer system 700 can execute a version of WINDOWS' operating system available from Microsoft Corporation of Redmond, Wash., although other operating systems (UNIX and Linux, for example), embedded software, and/or graphical user interfaces, can also be used.

Embodiments can be used in other devices such as handheld devices and embedded applications. Some examples of handheld devices include cellular phones, Internet Protocol devices, digital cameras, personal digital assistants (PDAs), and handheld PCs. In some embodiments, embedded applications can include a microcontroller, a digital signal processor (DSP), a system on a chip, network computers (NetPCs), set-top boxes, network hubs, wide area network (WAN) switches, or any other system that can perform one or more instructions in accordance with at least one embodiment.

In some embodiments, computer system 700 can include, without limitation, processor 702 that can include, without limitation, one or more execution units 708 to perform operations according to techniques described herein. In some embodiments, computer system 700 is a single-processor desktop or server system, but in another embodiment, the computer system 700 can be a multiprocessor system. In some embodiments, processor 702 can include, without limitation, a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. In some embodiments, processor 702 can be coupled to a processor bus 710 that can transmit data signals between processor 702 and other components in computer system 700.

In some embodiments, processor 702 can include, without limitation, a Level-1 (L1) internal cache memory (cache) cache 704. In some embodiments, processor 702 can have a single internal cache or multiple levels of internal cache. In some embodiments, the cache memory can reside external to processor 702. Other embodiments can also include a combination of both internal and external caches depending on particular implementation and needs. In some embodiments, register file 706 can store different types of data in various registers, including and without limitation, integer registers, floating-point registers, status registers, and instruction pointer registers.

In some embodiments, an execution unit 708, including and without limitation, logic to perform integer and floating-point operations, also reside in processor 702. In some embodiments, processor 702 can also include a microcode (ucode) read-only memory (ROM) that stores microcode for certain macro instructions. In some embodiments, execution unit 708 can include logic to handle an encryption module 709. In some embodiments, by including encryption module 709 in an instruction set of a general-purpose processor, such as processor 702, along with associated circuitry to execute instructions, operations used by many multimedia applications can be performed using packed data in a general-purpose processor, such as processor 702. In one or more embodiments, many multimedia applications can be accelerated and executed more efficiently by using the full width of a processor's data bus for performing operations on packed data, which can eliminate the need to transfer smaller units of data across the processor's data bus to perform one or more operations one data element at a time.

In some embodiments, execution unit 708 can also be used in microcontrollers, embedded processors, graphics devices, DSPs, and other types of logic circuits. In some embodiments, computer system 700 can include, without limitation, a memory 716. In some embodiments, memory 716 can be implemented as a Dynamic Random Access Memory (DRAM) device, a Static Random Access Memory (SRAM) device, a flash memory device, or other memory devices. In some embodiments, memory 716 can store instruction(s) 718 and/or data 720 represented by data signals that can be executed by processor 702.

In some embodiments, the system logic chip can be coupled to processor bus 710 and memory 716. In some embodiments, the system logic chip can include, without limitation, a memory controller hub (MCH), such as MCH 714, and processor 702 can communicate with MCH 714 via processor bus 710. In some embodiments, MCH 714 can provide a high bandwidth memory path 715 to memory 716 for instruction and data storage and for storage of graphics commands, data, and textures. In some embodiments, MCH 714 can direct data signals between processor 702, memory 716, and other components in computer system 700 and bridge data signals between processor bus 710, memory 716, and a system input/output (I/O) 711. In some embodiments, a system logic chip can provide a graphics port for coupling to a graphics controller. In some embodiments, MCH 714 can be coupled to memory 716 through a high bandwidth memory path 715, and graphics/video card 712 can be coupled to MCH 714 through an Accelerated Graphics Port (AGP) interconnect 713.

In some embodiments, computer system 700 can use the system I/O 711 that is a proprietary hub interface bus to couple the MCH 714 to I/O controller hub (ICH), such as ICH 730. In some embodiments, ICH 730 can provide direct connections to some I/O devices via a local I/O bus. In some embodiments, a local I/O bus can include, without limitation, a high-speed I/O bus for connecting peripherals to memory 716, chipset, and processor 702. Examples can include, without limitation, data storage 722, a transceiver 724, a firmware hub (flash Basic Input/Output System (BIOS)) 726, a network controller 728, a legacy I/O controller 732 containing a user input interface 734, a serial expansion port 736, such as Universal Serial Bus (USB), and an audio controller 738. In some embodiments, data storage 722 can include a hard disk drive, a floppy disk drive, a compact disc read-only memory (CD-ROM) device, a flash memory device, or other mass storage devices.

In some embodiments, FIG. 7 illustrates a computer system 700, which includes interconnected hardware devices or “chips,” whereas, in other embodiments, FIG. 7 can illustrate an exemplary System on a Chip (SoC). In some embodiments, devices can be interconnected with proprietary interconnects, standardized interconnects (e.g., Peripheral Component Interconnect buses (e.g., PCI, PCI Express)), or some combination thereof. In some embodiments, one or more components of computer system 700 are interconnected using compute express link (CXL) interconnects.

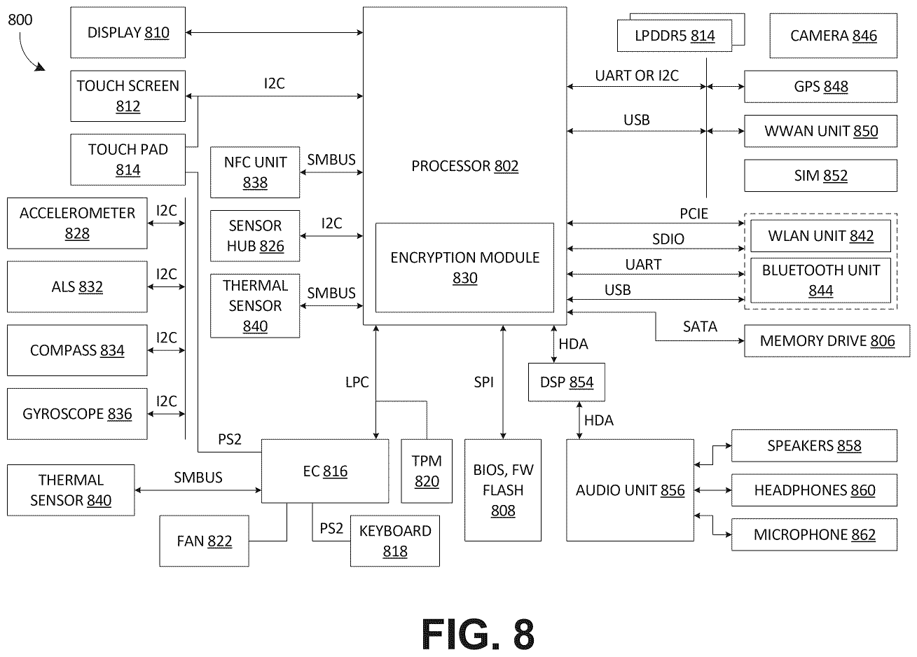

FIG. 8 is a block diagram illustrating an electronic device 800 for utilizing a processor 802, according to some aspects of the disclosure. In some embodiments, electronic device 800 can be, for example, and without limitation, a notebook, a tower server, a rack server, a blade server, a laptop, a desktop, a tablet, a mobile device, a phone, an embedded computer, or any other suitable electronic device.

In some embodiments, electronic device 800 can include, without limitation, processor 802 communicatively coupled to any suitable number or kind of components, peripherals, modules, or devices. In some embodiments, processor 802 coupled using a bus or interface, such as an Inter-Integrated Circuit (I2C) bus, a System Management Bus (SMBus), a Low Pin Count (LPC) bus, a Serial Peripheral Interface (SPI), a High Definition Audio (HDA) bus, a Serial Advance Technology Attachment (SATA) bus, a Universal Serial Bus (USB) (including USB 1.0/1/1, USB 2.0, USB 3.0/3.1 Gen 1/3.1Gen 2 , and USB 4), or a Universal Asynchronous Receiver/Transmitter (UART) bus. In some embodiments, FIG. 8 illustrates a system, which includes interconnected hardware devices or “chips,” whereas in other embodiments, FIG. 8 can illustrate an exemplary System on a Chip (SoC). In some embodiments, devices illustrated in FIG. 8 can be interconnected with proprietary interconnects, standardized interconnects (e.g., PCIe), or some combination thereof. In some embodiments, one or more components of FIG. 8 are interconnected using compute express link (CXL) interconnects.

In some embodiments, FIG. 8 can include a display 810, a touch screen 812, a touch pad 814, a Near Field Communications unit (NFC) 838, a sensor hub 826, a thermal sensor 840, an Express Chipset (EC), such as EC 816, a Trusted Platform Module (TPM), such as TPM 820, BIOS/firmware(FW)/flash memory, such as BIOS, FW Flash 808, a DSP 854, a memory drive 806 such as a Solid State Disk (SSD) or a Hard Disk Drive (HDD), a wireless local area network unit (WLAN), such as WLAN unit 842, a Bluetooth unit 844, a Wireless Wide Area Network unit (WWAN), such as WWAN unit 850, a Global Positioning System (GPS) 848, a camera (USB 3.0 camera) 846, such as a USB 3.0 camera, and/or a Low Network bandwidth Double Data Rate (LPDDR) memory unit, such as LPDDR5 804 implemented in, for example, LPDDR5 standard. These components can each be implemented in any suitable manner.

In some embodiments, other components can be communicatively coupled to processor 802 through the components discussed above. In some embodiments, processor 802 can include an encryption module 830. In some embodiments, an accelerometer 828, Ambient Light Sensor (ALS), such as ALS 832, compass 834, and a gyroscope 836 can be communicatively coupled to sensor hub 826. In some embodiments, thermal sensor 840, a fan 822, a keyboard 818, and a touch pad 814 can be communicatively coupled to EC 816. In some embodiments, speakers 858, headphones 860, and microphone 862 can be communicatively coupled to an audio unit 856 which can, in turn, be communicatively coupled to DSP 854. In some embodiments, audio unit 856 can include, for example, and without limitation, an audio coder/decoder (codec) and a class-D amplifier. In some embodiments, a subscriber identification module (SIM) card, such as SIM 852 can be communicatively coupled to WWAN unit 850. In some embodiments, components such as WLAN unit 842 and Bluetooth unit 844, as well as WWAN unit 850 can be implemented in a Next Generation Form Factor (NGFF).

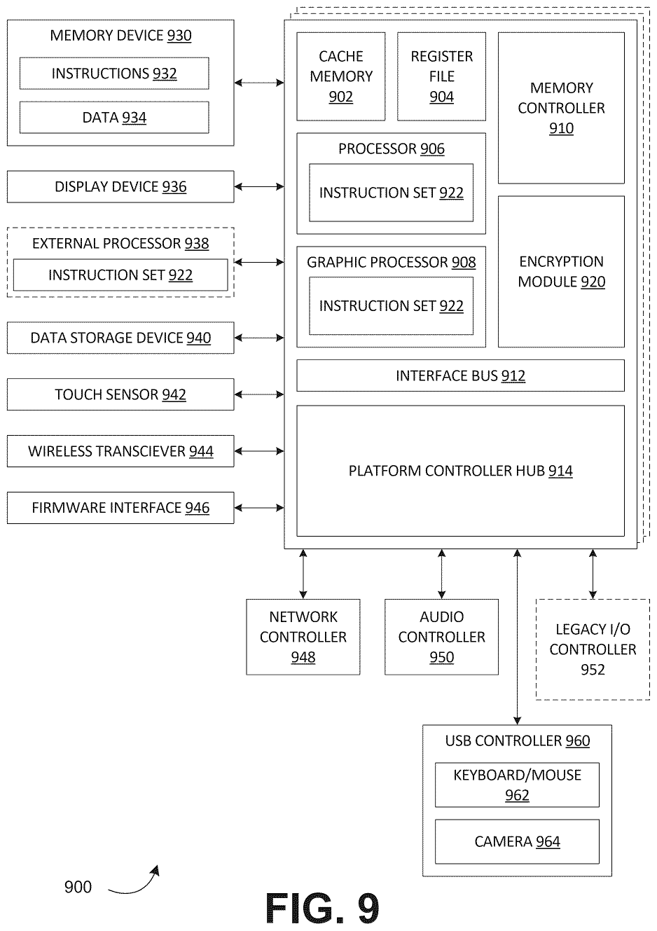

FIG. 9 is a block diagram of a processing system 900, according to some aspects of the disclosure. In some embodiments, the processing system 900 includes cache memory 902, register file 904, processors 906, graphics processors 908, memory controller 910, interface bus 912, platform controller hub 914, and an encryption module 920. Processing system 900 can be a single processor desktop system, a multiprocessor workstation system, or a server system having a large number of processors 906 or graphics processors 908. In some embodiments, the processing system 900 is a processing platform incorporated within a system-on-a-chip (SoC) integrated circuit for use in mobile, handheld, or embedded devices.

In some embodiments, the processing system 900 can include, or be incorporated within a server-based gaming platform, a game console, including a game and media console, a mobile gaming console, a handheld game console, or an online game console. In some embodiments, the processing system 900 is a mobile phone, smart phone, tablet computing device, or mobile Internet device. In some embodiments, the processing system 900 can also include, couple with, or be integrated within, a wearable device, such as a smart watch wearable device, smart eyewear device, augmented reality device, or virtual reality device. In some embodiments, the processing system 900 is a television or set-top box device having one or more processors 906 and a graphical interface generated by one or more graphics processors 908.

In some embodiments, one or more processors 906 each include one or more of the processor cores to process instructions which, when executed, perform operations for system and user software. In some embodiments, one or more processors 906 and/or one or more graphics processors can be configured to process a portion of the instruction set 922. In some embodiments, Instruction set 922 can facilitate Complex Instruction Set Computing (CISC), Reduced Instruction Set Computing (RISC), or computing via a Very Long Instruction Word (VLIW). In some embodiments, processor cores can each process a different instruction set from Instruction set 922, which can include instructions to facilitate emulation of other instruction sets (not illustrated). In some embodiments, processor cores can also include other processing devices, such as a Digital Signal Processor (DSP).

In some embodiments, processors 906 includes cache memory 902. In some embodiments, processors 906 can have a single internal cache or multiple levels of internal cache. In some embodiments, cache memory 902 is shared among various components of processors 906. In some embodiments, processors 906 also uses an external cache (e.g., a Level-3 (L3) cache or Last Level Cache (LLC)) (not illustrated), which can be shared among processor cores using known cache coherency techniques. In some embodiments, register file 904 is additionally included in processors 906, which can include different types of registers for storing different types of data (e.g., integer registers, floating-point registers, status registers, and an instruction pointer register). In some embodiments, register file 904 can include general-purpose registers or other registers.

In some embodiments, one or more processors 906 are coupled with one or more interface bus 912 to transmit communication signals such as address, data, or control signals between processor cores and other components in processing system 900. In some embodiments, interface bus 912, in one embodiment, can be a processor bus, such as a version of a Direct Media Interface (DMI) bus. In some embodiments, interface bus 912 is not limited to a DMI bus, and can include one or more peripheral component interconnect (PCI) buses (e.g., PCI, PCI Express), memory busses, or other types of interface busses. In some embodiments, processors 906 include an integrated memory controller (e.g., memory controller 910) and a platform controller hub 914 (PCH). In some embodiments, memory controller 910 facilitates communication between a memory device and other components of the processing system 900, while platform controller hub 914 provides connections to I/O devices via a local I/O bus.

In some embodiments, the memory device 930 can be a dynamic random-access memory (DRAM) device, a static random-access memory (SRAM) device, a flash memory device, a phase-change memory device, or some other memory device having suitable performance to serve as process memory. In some embodiments, the memory device 930 can operate as system memory for processing system 900 to store instructions 932 and data 934 for use when one or more processors 906 executes an application or process. In some embodiments, memory controller 910 also optionally couples with an external processor 938, which can communicate with one or more graphics processors 908 in processors 906 to perform graphics and media operations. In some embodiments, a display device 936 can connect to processors 906. In some embodiments, the display device 936 can include one or more of an internal display device, as in a mobile electronic device or a laptop device, or an external display device attached via a display interface (e.g., DisplayPort, etc.). In some embodiments, display device 936 can include a head-mounted display (HMD) such as a stereoscopic display device for use in virtual reality (VR) applications or augmented reality (AR) applications.

In some embodiments, the platform controller hub 914 enables peripherals to connect to memory device 930 and processors 906 via a high-speed I/O bus. In some embodiments, I/O peripherals include, but are not limited to, a data storage device 940 (e.g., hard disk drive, flash memory, etc.), a touch sensor 942, a wireless transceiver 944, firmware interface 946, a network controller 948, or an audio controller 950.

In some embodiments, the data storage device 940 can connect via a storage interface (e.g., SATA) or via a peripheral bus, such as a PCI bus (e.g., PCI, PCI Express). In some embodiments, touch sensor 942 can include touch screen sensors, pressure sensors, or fingerprint sensors. In some embodiments, wireless transceiver 944 can be a Wi-Fi transceiver, a Bluetooth transceiver, or a mobile network transceiver such as a 3G, 4G, Long Term Evolution (LTE), 5G, or 6G transceiver. In some embodiments, firmware interface 946 enables communication with system firmware and can be, for example, a unified extensible firmware interface (UEFI). In some embodiments, the network controller 948 can enable a network connection to a wired network. In some embodiments, a high-performance network controller (not illustrated) couples with interface bus 912. In some embodiments, audio controller 950 can be a multi-channel high-definition audio controller. In some embodiments, the processing system 900 includes an optional legacy I/O controller 952 for coupling legacy (e.g., Personal System-2 (PS/2)) devices to the processing system 900. In some embodiments, the platform controller hub 914 can also connect to one or more Universal Serial Bus (USB) controllers, such as USB controller 960 to connect input devices, such as a keyboard and mouse combination (keyboard/mouse 962), a camera 964, or other USB input devices.

In some embodiments, an instance of memory controller 910 and platform controller hub 914 can be integrated into a discreet external graphics processor, such as external processor 938. In some embodiments, the platform controller hub 914 and/or memory controller 910 can be external to one or more processors 906. For example, in some embodiments, the processing system 900 can include an external memory controller (e.g., memory controller 910) and the platform controller hub 914, which can be configured as a memory controller hub and peripheral controller hub within a system chipset that is in communication with the processors 906.

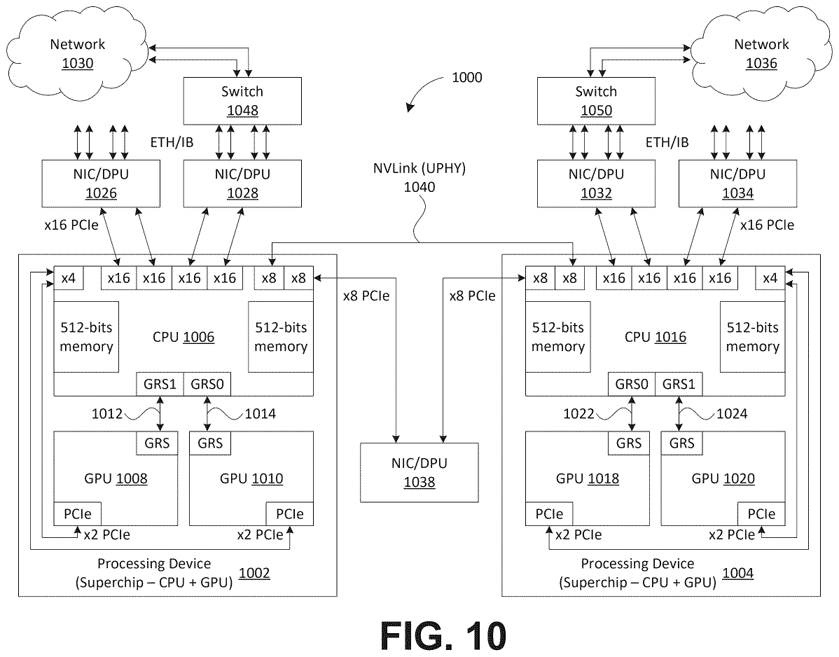

FIG. 10 is a block diagram that schematically illustrates a computing system 1000, e.g., a data center or a High-Performance Computing (HPC) cluster, in accordance with an embodiment that is described herein. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 10 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 3, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 3, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communication with each other via a NIC/DPU 1038, such as over PCIe interconnects.

Processing device 1002 and processing device 1004 can also communicate with each other over a high-bandwidth communication interconnects 1040, such as an NVLink interconnect or other high-speed interconnects. The packet switches in FIG. 3 may comprise, for example, Nvidia Quantum-2 switches. The NICs/DPUs in the figure may comprise, for example, Nvidia Bluefield DPUs.

The computing system 1000 includes various types of interconnects. Each of the interconnects includes the transceivers or receivers that include the transceiver logic 220 or transceiver logic 240 of FIG. 2, as described herein.

In at least one embodiment, the computing system 1000 is used for high-speed network communication and includes a processing unit (e.g., CPU 1006, GPU 1008, GPU 1008, CPU 1016, GPU 1018, GPU 1020, NIC/DPU 1026, NIC/DPU 1028, NIC/DPU 1032, NIC/DPU 1034, or NIC/DPU 1038), and a network interface coupled to the processing unit. The network interface includes a transceiver circuit operatively coupled to a controller. The transceiver circuit includes an encryption module which is controlled by the controller, as described above. The encryption keys are rotated based on commands received at the encryption module from the controller. The connection between the controller and the encryption module is a local, trusted connection. The communication network that connects the processing device 1002 to the processing device 1004 does not include a connection to the controller, or otherwise process or send encryption keys.

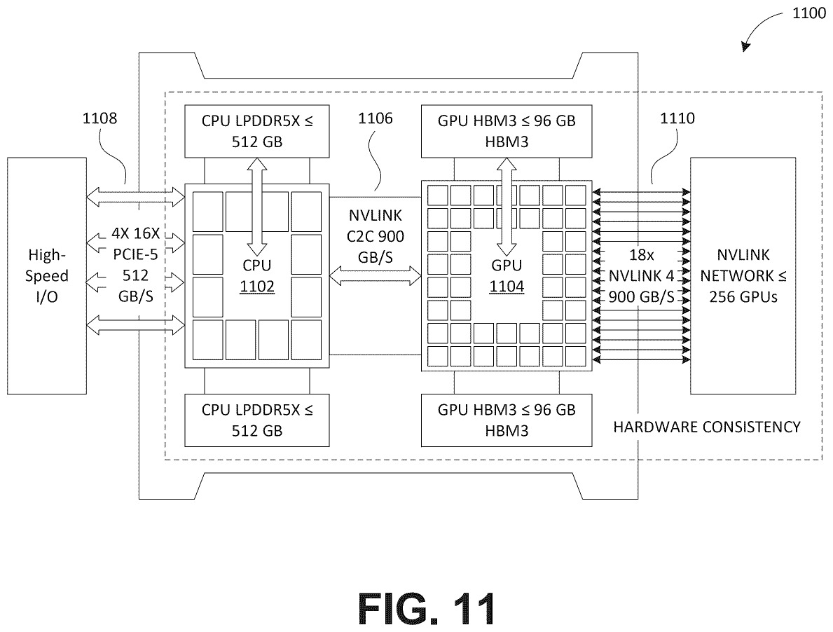

FIG. 11 is a block diagram of a computing system 1100 having a CPU 1102 and a GPU 1104 in a single integrated circuit according to at least one embodiment. The computing system 1100 can be a highly integrated design where a CPU 1102 and GPU 1104 are connected on a single integrated circuit, utilizing an NVLink C2C (Chip-to-Chip) interconnect 1106 to enable fast, low-latency communication between the two processing units. This close integration allows for efficient data transfer and parallel processing between the CPU 1102 and GPU 1104, optimizing performance for complex computational tasks. The GPU elements within the computing system 1100 can be interconnected using an NVLink network, allowing for scalability to include multiple GPU elements (e.g., up to 256 as illustrated), creating a powerful, unified processing environment ideal for large-scale AI, ML, and high-performance computing applications. The NVLink network can be a GPU fabric of high-bandwidth communication interconnects 1110. Additionally, the computing system 1100 can be designed to interface with a high-speed I/O through PCIe interconnects 1108, ensuring rapid data transfer to and from external devices, further enhancing the system's capabilities in handling data-intensive tasks and providing robust connectivity to peripheral components. It should be noted that the C2C interconnects 1106 can be considered D2D interconnects since the CPU 1102 and the GPU 1104 are located on the same integrated circuit. The integrated circuit can include CPU memory (also referred to as main memory) and GPU memory, which are accessible by the CPU 1102 and the GPU 1104, respectively, over high-speed interconnects. The computing system 1100 can bring together performance of the GPU 1104 with the versatility of the CPU 1102. The CPU 1102 can be connected with a high-bandwidth and memory coherent C2C interconnects 1106 in a single integrated circuit. The computing system 1100 can support a link switch system.

The computing system 1100 includes various types of interconnects. Each of the interconnects includes the transceivers or receivers that include the transceiver logic 220 or transceiver logic 240 of FIG. 2, as described herein.

In at least one embodiment, the computing system 1100 is used for high-speed network communication and includes a processing unit (e.g., CPU 1102, GPU 1104, NVLink network), and a network interface coupled to the processing unit. The network interface can include the controller as described above with respect to FIG. 10.

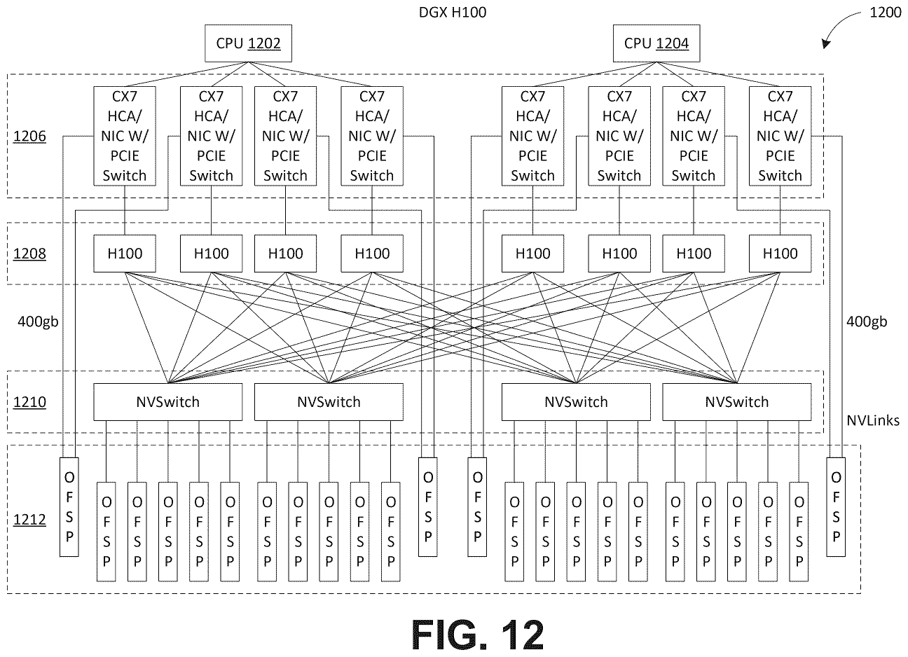

FIG. 12 is a block diagram of a computing system 1200 having tensor core GPUs 1208 according to at least one embodiment. The computing system 1200 can be an NVIDIA® DGX H100 system which is a high-performance computing platform designed to meet the demands of AI, ML, and deep learning (DL) workloads. The computing system 1200 can include multiple tensor core GPUs 1208 (e.g., NVIDIA H100 Tensor Core GPUs). The tensor core GPUs 1208 can each be one of the integrated circuits described above with respect to FIG. 10. The tensor core GPUs 1208 can be optimized for AI/ML/DL applications, offering exceptional performance for deep learning training, inference, and high-performance computing tasks. The tensor core GPUs 1208 within the computing system 1200 are interconnected using high-speed communication interfaces like NVLinks, enabling rapid data transfer between them, which is crucial for handling large-scale AI models and datasets with low latency. This computing system 1200 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 1208, the computing system 1200 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 1208 for their specific applications. The computing system 1200 is ideally suited for large-scale AI model training, real-time inference, scientific simulations, data analytics, and other compute-intensive tasks that require massive parallel processing power.

The tensor core GPUs 1208 can be coupled to multiple CPUs, such as CPU 1202 and CPU 1204, using switches 1206 (e.g., CX7 HCA/NIC with PCIe switch). The tensor core GPUs 1208 can be coupled to each other via switches 1210 (e.g., NV-Switches). The switches 1206 and switches 1210 can be coupled to high-speed transceiver modules 1212. The high-speed transceiver modules 1212 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 1200 remains capable of meeting increasing data demands and can be upgraded to support future advancements in network speeds, thus contributing to the system's overall performance and scalability.

In at least one embodiment, the computing system 1200 can be considered a data-network configuration with full-bandwidth intra-server NVLinks. In this example, all eight tensor core GPUs 1208 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 1208 can half-subscribe eighteen NVLinks to GPUs in other servers. Four tensor core GPUs 1208 can saturate eighteen NVLinks to GPUs in other servers. This is equivalent of full-bandwidth on AllReduce with Scalable Hierarchical Aggregation and Reduction Protocol (SHARP). The reduction in all 2-all (All2All) bandwidth is a balance with server complexity and costs. In at least one embodiment, all eight tensor core GPUs 1208 can independently transfer data, using Remote Direct Memory Access (RDMA) protocol, over its own dedicated switch (e.g., 400 Gb/s HCA/NIC) in an multi-rail InfiniBand/Ethernet configuration. In this example, 800 GBps of aggregate full-duplex to non-NVLink network devices.

The computing system 1200 includes various types of interconnects. Each of the interconnects includes the transceivers or receivers that include the transceiver logic 220 or transceiver logic 240 of FIG. 2, as described herein.

In at least one embodiment, the computing system 1200 is used for high-speed network communication and includes a processing unit (e.g., CPU 1202, CPU 1202, switches 1206, tensor core GPUs 1208, switches 1210, high-speed transceiver modules 1212), and a network interface coupled to the processing unit. The network interface can the controller as described above with respect to FIG. 10.

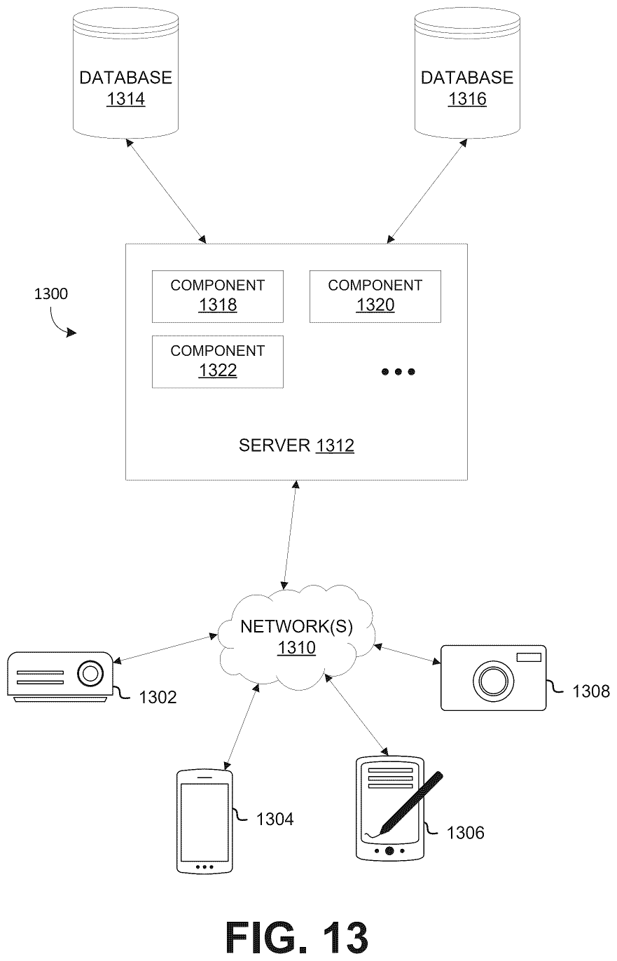

FIG. 13 illustrates a distributed system 1300, according to some aspects of the disclosure. In at least one embodiment, distributed system 1300 includes one or more client computing devices 1302, 1304, 1306, and 1308, which are configured to execute and operate a client application such as a web browser, proprietary client, and/or variations thereof over one or more networks 1310. In at least one embodiment, server 1312 may be communicatively coupled with remote client computing devices 1302, 1304, 1306, and 1308 via network 1310. In some embodiments, server 1312 includes a PCB having one or more power connectors as described herein above. In some embodiments, server 1312 receives electrical power via a power delivery system as described herein above.

In at least one embodiment, server 1312 may be adapted to run one or more services or software applications such as services and applications that may manage session activity of single sign-on (SSO) access across multiple data centers. In at least one embodiment, server 1312 may also provide other services or software applications can include non-virtual and virtual environments. In at least one embodiment, these services may be offered as web-based or cloud services or under a Software as a Service (Saas) model to users of client computing devices 1302, 1304, 1306, and/or 1308. In at least one embodiment, users operating client computing devices 1302, 1304, 1306, and/or 1308 may in turn utilize one or more client applications to interact with server 1312 to utilize services provided by these components.

In at least one embodiment, software components 1318, 1320 and 1322 of system 1300 are implemented on server 1312. In at least one embodiment, one or more components of system 1300 and/or services provided by these components may also be implemented by one or more of client computing devices 1302, 1304, 1306, and/or 1308. In at least one embodiment, users operating client computing devices may then utilize one or more client applications to use services provided by these components. In at least one embodiment, these components may be implemented in hardware, firmware, software, or combinations thereof. It should be appreciated that various different system configurations are possible, which may be different from distributed system 1300. The embodiment shown in FIG. 11 is thus one example of a distributed system for implementing an embodiment system and is not intended to be limiting.

In at least one embodiment, client computing devices 1302, 1304, 1306, and/or 1308 may include various types of computing systems. In at least one embodiment, a client computing device may include portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, and/or variations thereof. In at least one embodiment, devices may support various applications such as various Internet-related apps, e-mail, short message service (SMS) applications, and may use various other communication protocols. In at least one embodiment, client computing devices may also include general purpose personal computers including, by way of example, personal computers and/or laptop computers running various versions of Microsoft Windows®, Apple Macintosh®, and/or Linux operating systems. In at least one embodiment, client computing devices can be workstation computers running any of a variety of commercially-available UNIX® or UNIX-like operating systems, including without limitation a variety of GNU/Linux operating systems, such as Google Chrome OS. In at least one embodiment, client computing devices may also include electronic devices such as a thin-client computer, an Internet-enabled gaming system (e.g., a Microsoft Xbox gaming console with or without a Kinect® gesture input device), and/or a personal messaging device, capable of communicating over networks 1310. Although distributed system 1300 in FIG. 11 is shown with four client computing devices, any number of client computing devices may be supported. Other devices, such as devices with sensors, etc., may interact with server 1312.

In at least one embodiment, networks 1310 in distributed system 1300 may be any type of network that can support data communications using any of a variety of available protocols, including without limitation TCP/IP (transmission control protocol/Internet protocol), SNA (systems network architecture), IPX (Internet packet exchange), AppleTalk, and/or variations thereof. In at least one embodiment, networks 1310 can be a local area network (LAN), networks based on Ethernet, Token-Ring, a wide-area network, Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol), and/or any combination of these and/or other networks.

In at least one embodiment, server 1312 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In at least one embodiment, server 1312 can include one or more virtual machines running virtual operating systems, or other computing architectures involving virtualization. In at least one embodiment, one or more flexible pools of logical storage devices can be virtualized to maintain virtual storage devices for a server. In at least one embodiment, virtual networks can be controlled by server 1312 using software defined networking. In at least one embodiment, server 1312 may be adapted to run one or more services or software applications.

In at least one embodiment, server 1312 may run any operating system, as well as any commercially available server operating system. In at least one embodiment, server 1312 may also run any of a variety of additional server applications and/or mid-tier applications, including HTTP (hypertext transport protocol) servers, FTP (file transfer protocol) servers, CGI (common gateway interface) servers, JAVA® servers, database servers, and/or variations thereof. In at least one embodiment, exemplary database servers include without limitation those commercially available from Oracle, Microsoft, Sybase, IBM (International Business Machines), and/or variations thereof.

In at least one embodiment, server 1312 may include one or more applications to analyze and consolidate data feeds and/or event updates received from users of client computing devices 1302, 1304, 1306, and 1308. In at least one embodiment, data feeds and/or event updates may include, but are not limited to, Twitter@ feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and/or variations thereof. In at least one embodiment, server 1312 may also include one or more applications to display data feeds and/or real-time events via one or more display devices of client computing devices 1302, 1304, 1306, and 1308.

In at least one embodiment, distributed system 1300 may also include one or more databases 1314 and 1316. In at least one embodiment, databases may provide a mechanism for storing information such as user interactions information, usage patterns information, adaptation rules information, and other information. In at least one embodiment, databases 1314 and 1316 may reside in a variety of locations. In at least one embodiment, one or more of databases 1314 and 1316 may reside on a non-transitory storage medium local to (and/or resident in) server 1312. In at least one embodiment, databases 1314 and 1316 may be remote from server 1312 and in communication with server 1312 via a network-based or dedicated connection. In at least one embodiment, databases 1314 and 1316 may reside in a storage-area network (SAN). In at least one embodiment, any necessary files for performing functions attributed to server 1312 may be stored locally on server 1312 and/or remotely, as appropriate. In at least one embodiment, databases 1314 and 1316 may include relational databases, such as databases that are adapted to store, update, and retrieve data in response to SQL-formatted commands.

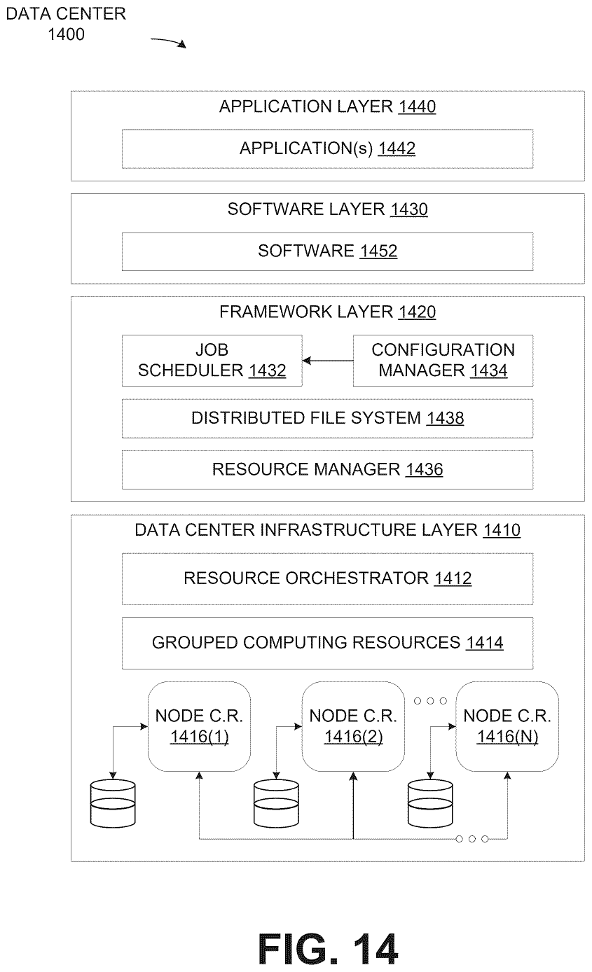

FIG. 14 illustrates an exemplary data center 1400, according to some aspects of the disclosure. In at least one embodiment, data center 1400 includes, without limitation, a data center infrastructure layer 1410, a framework layer 1420, a software layer 1430 and an application layer 1440.

In at least one embodiment, as shown in FIG. 12, data center infrastructure layer 1410 may include a resource orchestrator 1412, grouped computing resources 1414, and node computing resources (“node C. R. s”) 1416(1)-1416(N), where “N” represents any whole, positive integer. In at least one embodiment, node C. R. s 1416(1)-216(N) may include, but are not limited to, any number of central processing units (“CPUs”) or other processors (including accelerators, field programmable gate arrays (“FPGAs”), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C. R. s from among node C. R. s 1416(1)-1416(N) may be a server having one or more of above-mentioned computing resources.

In at least one embodiment, grouped computing resources 1414 may include separate groupings of node C. R. s housed within one or more racks (not shown), or many racks housed in data centers at various geographical locations (also not shown). Separate groupings of node C. R. s within grouped computing resources 1414 may include grouped compute, network, memory or storage resources that may be configured or allocated to support one or more workloads. In at least one embodiment, several node C. R. s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 1412 may configure or otherwise control one or more node C. R. s 1416(1)-1416(N) and/or grouped computing resources 1414. In at least one embodiment, resource orchestrator 1412 may include a software design infrastructure (“SDI”) management entity for data center 1400. In at least one embodiment, resource orchestrator 1412 may include hardware, software or some combination thereof.

In at least one embodiment, as shown in FIG. 12, framework layer 1420 includes, without limitation, a job scheduler 1432, a configuration manager 1434, a resource manager 1436 and a distributed file system 1438. In at least one embodiment, framework layer 1420 may include a framework to support software 1452 of software layer 1430 and/or one or more applications 1442 of application layer 1440. In at least one embodiment, software 1452 or applications 1442 may respectively include web-based service software or applications, such as those provided by Amazon Web Services, Google Cloud and Microsoft Azure. In at least one embodiment, framework layer 1420 may be, but is not limited to, a type of free and open-source software web application framework such as Apache Spark™ (hereinafter “Spark”) that may utilize distributed file system 1438 for large-scale data processing (e.g., “big data”). In at least one embodiment, job scheduler 1432 may include a Spark driver to facilitate scheduling of workloads supported by various layers of data center 1400. In at least one embodiment, configuration manager 1434 may be capable of configuring different layers such as software layer 1430 and framework layer 1420, including Spark and distributed file system 1438 for supporting large-scale data processing. In at least one embodiment, resource manager 1436 may be capable of managing clustered or grouped computing resources mapped to or allocated for support of distributed file system 1438 and job scheduler 1432. In at least one embodiment, clustered or grouped computing resources may include grouped computing resource 1414 at data center infrastructure layer 1410. In at least one embodiment, resource manager 1436 may coordinate with resource orchestrator 1412 to manage these mapped or allocated computing resources.

In at least one embodiment, software 1452 included in software layer 1430 may include software used by at least portions of node C. R. s 1416(1)-1416(N), grouped computing resources 1414, and/or distributed file system 1438 of framework layer 1420. One or more types of software may include, but are not limited to, Internet web page search software, e-mail virus scan software, database software, and streaming video content software.

In at least one embodiment, applications 1442 included in application layer 1440 may include one or more types of applications used by at least portions of node C. R. s 1416(1)-1416(N), grouped computing resources 1414, and/or distributed file system 1438 of framework layer 1420. In at least one or more types of applications may include, without limitation, CUDA applications, 5G network applications, artificial intelligence application, data center applications, and/or variations thereof.

In at least one embodiment, any of configuration manager 1434, resource manager 1436, and resource orchestrator 1412 may implement any number and type of self-modifying actions based on any amount and type of data acquired in any technically feasible fashion. In at least one embodiment, self-modifying actions may relieve a data center operator of data center 1400 from making possibly bad configuration decisions and possibly avoiding underutilized and/or poor performing portions of a data center.

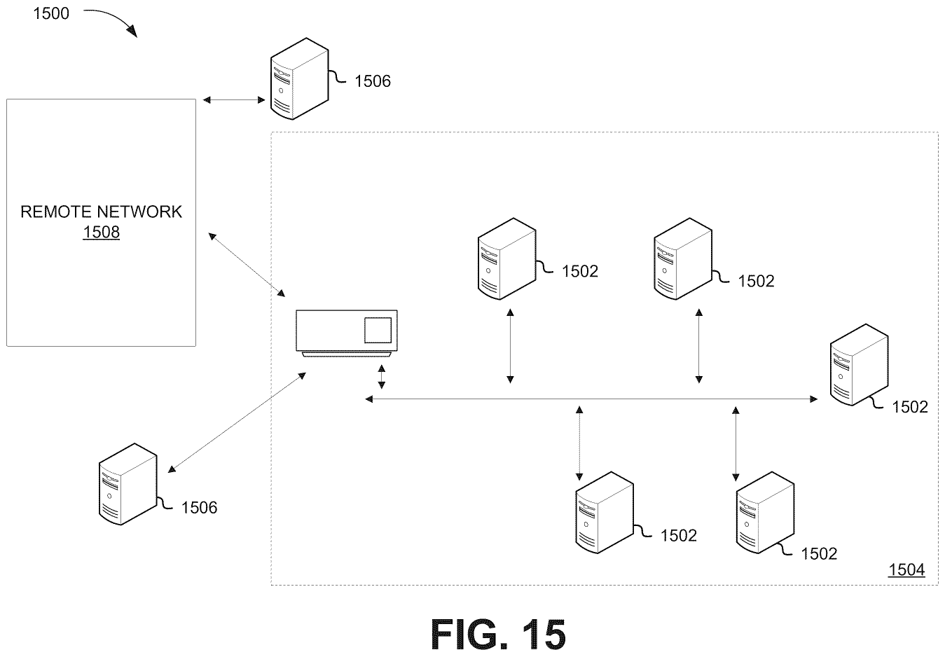

FIG. 15 illustrates a system 1500 that includes client-server network 1504 formed by a plurality of network server computers 1502 which are interlinked, according to some aspects of the disclosure. In at least one embodiment, each network server computer 1502 stores data accessible to other network server computers 1502 and to client computers 1506 and networks 1508 which link into a wide area network 1504. In at least one embodiment, configuration of a client-server network 1504 may change over time as client computers 1506 and one or more networks 1508 connect and disconnect from a network 1504, and as one or more trunk line server computers 1502 are added or removed from a network 1504. In at least one embodiment, when a client computer 1506 and a network 1508 are connected with network server computers 1502, client-server network includes such client computer 1506 and network 1508. In at least one embodiment, the term computer includes any device or machine capable of accepting data, applying prescribed processes to data, and supplying results of processes.

In at least one embodiment, client-server network 1504 stores information which is accessible to network server computers 1502, remote networks 1508 and client computers 1506. In at least one embodiment, network server computers 1502 are formed by main frame computers minicomputers, and/or microcomputers having one or more processors each. In at least one embodiment, server computers 1502 are linked together by wired and/or wireless transfer media, such as conductive wire, fiber optic cable, and/or microwave transmission media, satellite transmission media or other conductive, optic or electromagnetic wave transmission media. In at least one embodiment, client computers 1506 access a network server computer 1502 by a similar wired or a wireless transfer medium. In at least one embodiment, a client computer 1506 may link into a client-server network 1504 using a modem and a standard telephone communication network. In at least one embodiment, alternative carrier systems such as cable and satellite communication systems also may be used to link into client-server network 1504. In at least one embodiment, other private or time-shared carrier systems may be used. In at least one embodiment, network 1504 is a global information network, such as the Internet. In at least one embodiment, network is a private intranet using similar protocols as the Internet, but with added security measures and restricted access controls. In at least one embodiment, network 1504 is a private, or semi-private network using proprietary communication protocols.

In at least one embodiment, client computer 1506 is any end user computer, and may also be a mainframe computer, mini-computer or microcomputer having one or more microprocessors. In at least one embodiment, server computer 1502 may at times function as a client computer accessing another server computer 1502. In at least one embodiment, remote network 1508 may be a local area network, a network added into a wide area network through an independent service provider (ISP) for the Internet, or another group of computers interconnected by wired or wireless transfer media having a configuration which is either fixed or changing over time. In at least one embodiment, client computers 1506 may link into and access a network 1504 independently or through a remote network 1508.

FIG. 16 illustrates a system 1600 including a computer network 1608 connecting one or more computing machines, according to some aspects of the disclosure. In at least one embodiment, network 1608 may be any type of electronically connected group of computers including, for instance, the following networks: Internet, Intranet, Local Area Networks (LAN), Wide Area Networks (WAN) or an interconnected combination of these network types. In at least one embodiment, connectivity within a network 1608 may be a remote modem, Ethernet (IEEE 802.3), Token Ring (IEEE 802.5), Fiber Distributed Datalink Interface (FDDI), Asynchronous Transfer Mode (ATM), or any other communication protocol. In at least one embodiment, computing devices linked to a network may be desktop, server, portable, handheld, set-top box, personal digital assistant (PDA), a terminal, or any other desired type or configuration. In at least one embodiment, depending on their functionality, network connected devices may vary widely in processing power, internal memory, and other performance aspects. In at least one embodiment, communications within a network and to or from computing devices connected to a network may be either wired or wireless. In at least one embodiment, network 1608 may include, at least in part, the world-wide public Internet which generally connects a plurality of users in accordance with a client-server model in accordance with a transmission control protocol/internet protocol (TCP/IP) specification. In at least one embodiment, client-server network is a dominant model for communicating between two computers. In at least one embodiment, a client computer (“client”) issues one or more commands to a server computer (“server”). In at least one embodiment, server fulfills client commands by accessing available network resources and returning information to a client pursuant to client commands. In at least one embodiment, client computer systems and network resources resident on network servers are assigned a network address for identification during communications between elements of a network. In at least one embodiment, communications from other network connected systems to servers will include a network address of a relevant server/network resource as part of communication so that an appropriate destination of a data/request is identified as a recipient. In at least one embodiment, when a network 1608 comprises the global Internet, a network address is an IP address in a TCP/IP format which may, at least in part, route data to an e-mail account, a website, or other Internet tool resident on a server. In at least one embodiment, information and services which are resident on network servers may be available to a web browser of a client computer through a domain name (e.g. www.site.com) which maps to an IP address of a network server.

In at least one embodiment, a plurality of clients 1602, 1604, and 1606 are connected to a network 1608 via respective communication links. In at least one embodiment, each of these clients may access a network 1608 via any desired form of communication, such as via a dial-up modem connection, cable link, a digital subscriber line (DSL), wireless or satellite link, or any other form of communication. In at least one embodiment, each client may communicate using any machine that is compatible with a network 1608, such as a personal computer (PC), work station, dedicated terminal, personal data assistant (PDA), or other similar equipment. In at least one embodiment, clients 1602, 1604, and 1606 may or may not be located in a same geographical area.

In at least one embodiment, a plurality of servers 1610, 1612, and 1614 are connected to a network 1608 to serve clients that are in communication with a network 1608. In at least one embodiment, each server is typically a powerful computer or device that manages network resources and responds to client commands. In at least one embodiment, servers include computer readable data storage media such as hard disk drives and RAM memory that store program instructions and data. In at least one embodiment, servers 1610, 1612, 1614 run application programs that respond to client commands. In at least one embodiment, server 1610 may run a web server application for responding to client requests for HTML pages and may also run a mail server application for receiving and routing electronic mail. In at least one embodiment, other application programs, such as an FTP server or a media server for streaming audio/video data to clients may also be running on a server 1610. In at least one embodiment, different servers may be dedicated to performing different tasks. In at least one embodiment, server 1610 may be a dedicated web server that manages resources relating to web sites for various users, whereas a server 1612 may be dedicated to provide electronic mail (email) management. In at least one embodiment, other servers may be dedicated for media (audio, video, etc.), file transfer protocol (FTP), or a combination of any two or more services that are typically available or provided over a network. In at least one embodiment, each server may be in a location that is the same as or different from that of other servers. In at least one embodiment, there may be multiple servers that perform mirrored tasks for users, thereby relieving congestion or minimizing traffic directed to and from a single server. In at least one embodiment, servers 1610, 1612, 1614 are under control of a web hosting provider in a business of maintaining and delivering third party content over a network 1608.

In at least one embodiment, web hosting providers deliver services to two different types of clients. In at least one embodiment, one type, which may be referred to as a browser, requests content from servers 1610, 1612, 1614 such as web pages, email messages, video clips, etc. In at least one embodiment, a second type, which may be referred to as a user, hires a web hosting provider to maintain a network resource such as a web site, and to make it available to browsers. In at least one embodiment, users contract with a web hosting provider to make memory space, processor capacity, and communication bandwidth available for their desired network resource in accordance with an amount of server resources a user desires to utilize.

In at least one embodiment, in order for a web hosting provider to provide services for both of these clients, application programs which manage a network resources hosted by servers must be properly configured. In at least one embodiment, program configuration process involves defining a set of parameters which control, at least in part, an application program's response to browser requests and which also define, at least in part, a server resources available to a particular user.

In one embodiment, an intranet server 1616 is in communication with a network 1608 via a communication link. In at least one embodiment, intranet server 1616 is in communication with a server manager 1618. In at least one embodiment, server manager 1618 comprises a database of an application program configuration parameters which are being utilized in servers 1610, 1612, 1614. In at least one embodiment, users modify a database 1620 via an intranet 1616, and a server manager 1618 interacts with servers 1610, 1612, 1614 to modify application program parameters so that they match a content of a database. In at least one embodiment, a user logs onto an intranet server 1616 by connecting to an intranet 1616 via client 1602 and entering authentication information, such as a username and password.

In at least one embodiment, when a user wishes to sign up for new service or modify an existing service, an intranet server 1616 authenticates a user and provides a user with an interactive screen display/control panel that allows a user to access configuration parameters for a particular application program. In at least one embodiment, a user is presented with a number of modifiable text boxes that describe aspects of a configuration of a user's web site or other network resource. In at least one embodiment, if a user desires to increase memory space reserved on a server for its web site, a user is provided with a field in which a user specifies a desired memory space. In at least one embodiment, in response to receiving this information, an intranet server 1616 updates a database 1620. In at least one embodiment, server manager 1618 forwards this information to an appropriate server, and a new parameter is used during application program operation. In at least one embodiment, an intranet server 1616 is configured to provide users with access to configuration parameters of hosted network resources (e.g., web pages, email, FTP sites, media sites, etc.), for which a user has contracted with a web hosting service provider.

FIG. 17A illustrates a networked computer system 1700A, according to some aspects of the disclosure. In at least one embodiment, networked computer system 1700A comprises a plurality of personal computers (“PCs”) or nodes 1702, 1718, 1720. In at least one embodiment, personal computer or node 1702 comprises a processor 1714, memory 1716, video camera 1704, microphone 1706, mouse 1708, speakers 1710, and monitor 1712. In at least one embodiment, nodes 1702, 1718, 1720 may each run one or more desktop servers of an internal network within a given company, for instance, or may be servers of a general network not limited to a specific environment. In at least one embodiment, there is one server per PC node of a network, so that each PC node of a network represents a particular network server, having a particular network URL address. In at least one embodiment, each server defaults to a default web page for that server's user, which may itself contain embedded URLs pointing to further subpages of that user on that server, or to other servers or pages on other servers on a network.

In at least one embodiment, nodes 1702, 1718, 1720 and other nodes of a network are interconnected via medium 1722. In at least one embodiment, medium 1722 may be, a communication channel such as an Integrated Services Digital Network (“ISDN”). In at least one embodiment, various nodes of a networked computer system may be connected through a variety of communication media, including local area networks (“LANs”), plain-old telephone lines (“POTS”), sometimes referred to as public switched telephone networks (“PSTN”), and/or variations thereof. In at least one embodiment, various nodes of a network may also constitute computer system users inter-connected via a network such as the Internet. In at least one embodiment, each server on a network (running from a particular node of a network at a given instance) has a unique address or identification within a network, which may be specifiable in terms of an URL.

In at least one embodiment, a plurality of multi-point conferencing units (“MCUs”) may thus be utilized to transmit data to and from various nodes or “endpoints” of a conferencing system. In at least one embodiment, nodes and/or MCUs may be interconnected via an ISDN link or through a local area network (“LAN”), in addition to various other communications media such as nodes connected through the Internet. In at least one embodiment, nodes of a conferencing system may, in general, be connected directly to a communications medium such as a LAN or through an MCU, and that a conferencing system may comprise other nodes or elements such as routers, servers, and/or variations thereof.

In at least one embodiment, processor 1714 is a general-purpose programmable processor. In at least one embodiment, processors of nodes of networked computer system 1700A may also be special-purpose video processors. In at least one embodiment, various peripherals and components of a node such as those of node 1702 may vary from those of other nodes. In at least one embodiment, node 1718 and node 1720 may be configured identically to or differently than node 1702. In at least one embodiment, a node may be implemented on any suitable computer system in addition to PC systems.

FIG. 17B illustrates a networked computer system 1700B, according to some aspects of the disclosure. In at least one embodiment, system 1700B illustrates a network such as LAN 1724, which may be used to interconnect a variety of nodes that may communicate with each other. In at least one embodiment, attached to LAN 1724 are a plurality of nodes such as PC nodes 1726, 1728, 1730. In at least one embodiment, a node may also be connected to the LAN via a network server or other means. In at least one embodiment, system 1700B comprises other types of nodes or elements, for example including routers, servers, and nodes.

FIG. 17C illustrates a networked computer system 1700B, according to some aspects of the disclosure. In at least one embodiment, system 1700C illustrates a WWW system having communications across a backbone communications network such as Network 1732, which may be used to interconnect a variety of nodes of a network. In at least one embodiment, WWW is a set of protocols operating on top of the Internet, and allows a graphical interface system to operate thereon for accessing information through the Internet. In at least one embodiment, attached to Network 1732 in WWW are a plurality of nodes such as PCs 1740, 1742, 1744. In at least one embodiment, a node is interfaced to other nodes of WWW through a WWW HTTP server such as servers 1734, 1736. In at least one embodiment, PC 1744 may be a PC forming a node of network 1732 and itself running its server 1736, although PC 1744 and server 1736 are illustrated separately in FIG. 17C for illustrative purposes.

In at least one embodiment, WWW is a distributed type of application, characterized by WWW HTTP, WWW's protocol, which runs on top of the Internet's transmission control protocol/Internet protocol (“TCP/IP”). In at least one embodiment, WWW may thus be characterized by a set of protocols (i.e., HTTP) running on the Internet as its “backbone.”

In at least one embodiment, a web browser is an application running on a node of a network that, in WWW-compatible type network systems, allows users of a particular server or node to view such information and thus allows a user to search graphical and text-based files that are linked together using hypertext links that are embedded in documents or files available from servers on a network that understand HTTP. In at least one embodiment, when a given web page of a first server associated with a first node is retrieved by a user using another server on a network such as the Internet, a document retrieved may have various hypertext links embedded therein and a local copy of a page is created local to a retrieving user. In at least one embodiment, when a user clicks on a hypertext link, locally-stored information related to a selected hypertext link is typically sufficient to allow a user's machine to open a connection across the Internet to a server indicated by a hypertext link.

In at least one embodiment, more than one user may be coupled to each HTTP server, for example through a LAN such as LAN 1738 as illustrated with respect to WWW HTTP server 1734. In at least one embodiment, system 1700C may also comprise other types of nodes or elements. In at least one embodiment, a WWW HTTP server is an application running on a machine, such as a PC. In at least one embodiment, each user may be considered to have a unique “server,” as illustrated with respect to PC 1744. In at least one embodiment, a server may be considered to be a server such as WWW HTTP server 1734, which provides access to a network for a LAN or plurality of nodes or plurality of LANs. In at least one embodiment, there are a plurality of users, each having a desktop PC or node of a network, each desktop PC potentially establishing a server for a user thereof. In at least one embodiment, each server is associated with a particular network address or URL, which, when accessed, provides a default web page for that user. In at least one embodiment, a web page may contain further links (embedded URLs) pointing to further subpages of that user on that server, or to other servers on a network or to pages on other servers on a network.

### Computer Networks

FIG. 18 illustrates a fat tree topology 1800 for a data center, according to some aspects of the disclosure. However, it is to be understood that the present disclosure is not limited to a fat tree topology. Other network topologies may also be contemplated within the scope of the disclosure. Examples of such alternative topologies include, but are not limited to, Slim Fly topology, which is designed to reduce the number of hops and cable lengths between nodes; Dragonfly topology, which aims to enhance network scalability and reduce latency through a hierarchical group of interconnected switches; and other hierarchical or non-hierarchical topologies that may be optimized for specific performance, scalability, or cost considerations. The principles and innovations disclosed herein can be applied to these and other network topologies to achieve similar advantages and benefits. Any modifications, variations, or adaptations of the network topologies that fall within the spirit and scope of the present disclosure are considered to be encompassed by this disclosure. In related art systems, a fat tree topology may use the same electrical switching devices on all layers (edge, aggregation, core). For example, each switching device may be 1 U switch, where 1 U refers to the industry standard size for rack-mounted switch and/or server. The interconnection between switches of different layers may be accomplished with optical links using active optical cables and optical transceivers implemented in a pluggable form factor (also referred to as “pluggables”).

As shown in FIG. 18, the fat tree topology may include three distinct layers: the edge layer 1802, the aggregation layer 1804, and the core layer 1806. The edge layer 1802, located at the bottom of the hierarchy, incorporates Top-of-Rack (ToR) network devices, such as network switches. In an alternative embodiment, the edge layer can incorporate an End-of-Row (EoR) or Middle-of-Row (MoR) network devices, such as network switches. The edge layer 1802 may serve as the initial point of aggregation for traffic originating from the servers. The servers and server racks are generally connected to the edge layer 1802, although they are not illustrated in the figure. The edge layer 1802 may include multiple network devices, designated as ELS1, ELS2, . . . , ELSn, as shown in FIG. 18. In some embodiments, the network devices in the edge layer are network switches, such as electrical network switches. The aggregation layer 1804 may be positioned above the edge layer 1802 and may further consolidate traffic from multiple edge layer network devices ELS1, ELS2, . . . , ELSn. The aggregation layer 1804 may be composed of network devices ALS1, ALS2, . . . , ALSo. In some embodiments, the network devices of the aggregation layer 1804 are network switches, such as optical network switches. The aggregation layer devices may be configured to aggregate data traffic from the edge layer 1802, ensuring efficient load balancing and data flow management. At the top of the hierarchy is the core layer 1806, which may provide high-speed interconnectivity and enables communication among different racks within the data center. The core layer 1806 may include a series of network devices labeled as CLS1, CLS2, . . . , CLSm. These core layer network devices (e.g., network switches) may be configured to ensure that data can traverse the network quickly and efficiently, minimizing latency and maximizing bandwidth.

As described herein, a high-capacity optical switch assemblies switch multiple channels of data at high data rates, with the number of channels reaching several hundreds and data rates reaching hundreds of Gb/s (Gb/s=10⁹ bits per second). In order to save power, it is desirable to co-package the switch itself with “optical engines,” which typically are small, high-density optical transceivers located within an application-specific integrated circuit (ASIC) or within an ASIC package together with the switch. The switch assembly is contained in a rack-mounted case, with optical receptacles on its front panel for ease of access. The signals from and to the ASIC are conveyed to and from the optical receptacles using optical fibers.

To further simplify installation and use, it is sometimes desirable that the optical cable be detachable from the transceivers so that a smaller cable may be routed through an installation. Each optical cable may, instead of comprising a transceiver, be designed to mate with a particular transceiver. The transceiver may be connected to a node, such as a server, and be used to connect a connector of each cable to the node as described herein.

Optical switches are one solution for enabling advances in networking due to the technology's potential for very high data capacity and low power consumption. Optical switches feature optical input and output ports and are capable of routing light that is coupled to the input ports to the intended output ports on demand, according to one or more control signals (electrical or optical control signals). Routing of the signals is performed in the optical domain, i.e. without the need for optical-electrical and electrical-optical conversion, thus bypassing the need for power-consuming transceivers. Header processing and buffering of the data is not possible in the optical domain and thus, packet switching (as it is realized in electrical switches) cannot be employed. Instead, the circuit switching paradigm is used: an end-to-end circuit is created for the communication between two endpoints connected on the input and the output of the optical switch. Director switches may be used in the most common data center interconnection topologies, e.g., fat trees, Slim Fly, and Dragonfly+).

An optical switch may include hardware and/or software for routing signals in the optical domain. Thus, in one embodiment, an optical switch may include input optical fibers and output optical fibers that carry optical signals as well as one or more devices suited for routing optical signals within the optical switch. For example, the one or more devices for routing optical signals may include one or more movable mirrors (e.g., MEMS mirrors) that are controlled to move in a manner that directs light from an input fiber to a desired output fiber or to move in a manner that forces or guides light from one waveguide into another waveguide. An optical switch may include one or more devices for amplifying light in order to compensate for propagation and scattering losses introduced by the optical switch. In at least one example embodiment, signals input and output to an ASIC are optical, meaning that each optical switch connected to an electrical switch routes optical signals received from the electrical switch without using hardware and/or software that converts an electrical signal into an optical signal for routing within the optical switch. However, example embodiments are not limited thereto, and an optical switch may include electrical to optical to electrical conversion hardware and/or software if desired (e.g., if the input signal and/or output signal is an electrical signal).

In some embodiments, the optical switch(es) may include an arrayed waveguide grating router (AWGR), which is a passive switch fabric. In some embodiments, the optical switch(es) may correspond to a passive element that operates as a wavelength router that uses multiple wavelengths to interconnect outputs and inputs by following a specific cyclic wavelength routing pattern.

In alternative embodiments, an optical switch may function by directly routing optical signals without converting them to electrical signals. Each optical switch may include optical receivers, such as photodetectors and wavelength-division multiplexing (WDM) demultiplexers, that receive incoming optical signals. These optical signals may then be directed through internal optical switching components, such as micro-electromechanical systems (MEMS) mirrors, waveguides, or optical cross-connects, which route the signals to the appropriate output paths. The optical switch may also include optical transmitters, such as laser diodes and modulators, which transmit the routed optical signals to the next switch in the network. A hybrid electro-optical switch (e.g., a “pod” as illustrated in FIG. 18) may combine both electrical and optical components to route signals. Such a switch may include receivers that convert optical signals into electrical signals using TIAs and photodetectors, similar to those in electrical switches. These electrical signals can then be routed within the switch using internal electrical switching circuitry. Additionally, the hybrid switch may contain optical switching components, such as WDM multiplexers and MEMS devices, to route optical signals directly. The transmitters in a hybrid switch may include both electrical-to-optical converters and direct optical transmitters, enabling the hybrid switch to interface with both electrical and optical networks. For example, a hybrid switch's transmitter may include a light source, a modulator for optical signals, and traditional electrical signal transmitters, providing routing capabilities across different signal domains.

The interconnections between the switches within the network topology 1800 may be implemented via optical fibers or traditional electrical cables, depending on the specific requirements of the system. For instance, the communication lanes may be constructed of dedicated differential cable pairs and/or fiber optics, each tailored to provide optimal performance for the data transmission needs. The dedicated differential cable pairs used in these interconnections may include a variety of cable media such as copper, aluminum, gold, silver, nickel, or composite materials like copper-clad aluminum, copper-clad steel, or bimetallic conductors. These materials may be chosen for their electrical conductivity and durability, ensuring reliable and efficient data transmission. For example, in a four-lane network, each lane may consist of its own dedicated copper cable, providing isolated physical paths for each communication lane of a deserialized data stream. This configuration helps in maintaining signal integrity and reducing crosstalk between lanes.

Alternatively, fiber optic cables may be employed for the interconnections. Fiber optics are capable of transmitting data streams via different wavelengths of light, with each data stream assigned a unique wavelength. The use of fiber optic cables may allow multiple data streams to be transmitted simultaneously through a single fiber optic cable, significantly increasing the bandwidth and efficiency of the network, and particularly advantageous for long-distance data transmission and for applications requiring high data transfer rates. Various optical networking technologies can be used to transmit multiple optical signals (e.g., data signals or data streams) over a single optical fiber within an optical link with little to no optical signal interference. These technologies may be used to improve bandwidth efficiency and reduce the amount of infrastructure needed for data communication. FIG. 16 illustrates a computer network topology that may be used in a data center. The illustrated computer network shows a multi-root tree topology, but it should be understood that other types of network topology are also contemplated, including fat tree and DCell network topologies.

FIG. 19 illustrates an example data center 1900, according to some aspects of the disclosure. In a data center that includes a variety of computing resources, there may be a number of distinct servers that perform data processing workloads. For example, the data center may include a number of racks, and each rack may include a number of distinct servers 1901. Each server 1901 may have a connection to a data center network, which may provide communication links between the servers 1901 and between individual servers 1901 and a central coordinating server. The servers 1901 may be organized into server groups 1902, for example with all of the servers in a single rack being in a single group. Any appropriate grouping of servers 1901 may be used.

Each of the server groups 1902 may be connected to the data center network by an access switch 1904. The access switch 1904 includes ports 1906, by which a physical medium 1908 connects respective servers 1901 to the access switch 1904. The physical medium 1908 may be any appropriate medium, such as twisted pair cables, coaxial cables, and optical fiber cables. The physical media 1908 provide bidirectional communications, so that the servers 1902 can send data to, and receive data from, the access switch 1904. Any appropriate number of servers 1901 may connect to a single access switch 1904, limited by the number of physical ports 1906 that the access switch 1904. Additionally, individual servers 1901 may be connected to multiple access switches 1904 for redundancy.

In at least some embodiments, the access switches 1904 may receive information on any of its physical ports 1906 and may direct that information to one or more of its physical ports 1906 in accordance with an intended destination of that information. For example, a first server in the network may transmit data intended for a second server in the network, with both the first server and the second server being connected by a physical medium 1908 to a same access switch 1904. The access switch 1904 may identify the destination for the data and may transmit that data on the physical medium 1908 corresponding to the second server, without retransmitting the data to other servers that may be connected to the access switch 1904.

Multiple access switches 1904 may, in turn, be connected to aggregating switches 1910 on an aggregating layer of the network topology. The aggregating switches 1910 may have a similar structure to the access switches 1904, with physical media connecting a port 1906 of each access switch 1904 to a port of a respective aggregating switch 1910. In at least some embodiments, the aggregating switches 1910 may connect to one another as well. Additionally, multiple access switches 1904 may be connected to multiple aggregating switches 1910 for redundancy.

During operation, the aggregating switches 1910 may transmit information between different access switches 1904. For example, if a first server 1901 is connected to a first access switch 1904 and transmits information that is destined for a second server 1901 on a second access switch 1904, then the first access switch may transmit the information to an aggregating switch 1910 that is connected to both access switches 1904. The second access switch 1904 then identifies the port belonging to the second server 1901 and transmits the information to its destination.

In at least some embodiments, the access switches 1904 and the aggregating switches 1910 establish a hierarchical structure that provides network connectivity to all of the servers 1901 within a data center. In at least some embodiments, a layer of core switches 1920 may be used to provide an interface between the data center network and a public network 1930. The core switches 1920 may operate as switches that connect the aggregating switches 1910 to one another and may also route information to and from the Internet.

Each of the switches described herein, including the access switches 1904, the aggregating switches 1910, and the core switches 1920, may be managed switches. A managed switch provides the network administrator with tools to control the operation of the switch, including changing the settings of individual ports 1906. For example, the administrator may use the managed switch to control quality of service settings by ensuring that certain ports have access to a specified amount of bandwidth. In another example, the administrator may configure ports to provide link aggregation, whereby a single device may connect to a switch by multiple ports 1906 to multiply its bandwidth.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. The term “connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. Use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper sub set of the corresponding set, but the subset and corresponding set can be equal.

Conjunctive language, such as phrases of the form “at least one of A, B, and C,” or “at least one of A, B, and C,” unless specifically stated otherwise or otherwise clearly contradicted by context, is otherwise understood with the context as used in general to present that an item, term, etc., can be either A or B or C, or any nonempty subset of a set of A and B and C. For instance, in an illustrative example of a set having three members, conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In some embodiments, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In some embodiments, code is stored on a computer-readable storage medium, for example, in form of a computer program comprising a plurality of instructions executable by one or more processors. In some embodiments, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In some embodiments, code (e.g., executable code or source code) is stored on a set of one or more non-transitory computer-readable storage media having stored thereon executable instructions (or other memory to store executable instructions, e.g., computer-readable instructions) that, when executed (i.e., as a result of being executed) by one or more processors of a computer system, cause a computer system to perform operations described herein. A set of non-transitory computer-readable storage media, in some embodiments, comprises multiple non-transitory computer-readable storage media and one or more of individual non-transitory storage media of multiple non-transitory computer-readable storage media lacks all of the code while multiple non-transitory computer-readable storage media collectively store all of the code. In some embodiments, executable instructions are executed such that different instructions are executed by different processors-for example, a non-transitory computer-readable storage medium stores instructions, and a main central processing unit (CPU) executes some of the instructions while a graphics processing unit (GPU) executes other instructions. In some embodiments, different components of a computer system have separate processors, and different processors execute different subsets of instructions.

Accordingly, in some embodiments, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples or exemplary language (e.g., “such as”) provided herein is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, can be used. It should be understood that these terms cannot be intended as synonyms for each other. Rather, in particular examples, “connected” or “coupled” can be used to indicate that two or more elements are in direct or indirect physical or electrical contact with each other. “Coupled” can also mean that two or more elements are not in direct contact with each other but yet still co-operate or interact with each other.

Unless specifically stated otherwise, it can be appreciated that throughout specification terms such as “processing,” “computing,” “calculating,” “determining,” or like, refer to action and/or processes of a computer or computing system or similar electronic computing device, that manipulates and/or transform data represented as physical, such as electronic, quantities within computing system's registers and/or memories into other data similarly represented as physical quantities within computing system's memories, registers or other such information storage, transmission or display devices.

In a similar manner, the term “processor” can refer to any device or portion of a device that processes electronic data from registers and/or memory and transform that electronic data into other electronic data that can be stored in registers and/or memory. As non-limiting examples, a “processor” can be a CPU or a GPU. A “computing platform” can comprise one or more processors. As used herein, “software” processes can include, for example, software and/or hardware entities that perform work over time, such as tasks, threads, and intelligent agents. Also, each process can refer to multiple processes for carrying out instructions in sequence or in parallel, continuously, or intermittently. The terms “system” and “method” are used herein interchangeably insofar as a system can embody one or more methods, and methods can be considered a system.

In the present document, references can be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface. In some implementations, the process of obtaining, acquiring, receiving, or inputting analog or digital data can be accomplished by transferring data via a serial or parallel interface. In another implementation, the process of obtaining, acquiring, receiving, or inputting analog or digital data can be accomplished by transferring data via a computer network from providing entity to acquiring entity. References can also be made to providing, outputting, transmitting, sending, or presenting analog or digital data. In various examples, the process of providing, outputting, transmitting, sending, or presenting analog or digital data can be accomplished by transferring data as an input or output parameter of a function call, a parameter of an application programming interface, or an interprocess communication mechanism.

Although the discussion above sets forth example implementations of described techniques, other architectures can be used to implement described functionality and are intended to be within the scope of this disclosure. Furthermore, although specific distributions of responsibilities are defined above for purposes of discussion, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
receiving an input comprising a natural language query requesting deployment information for at least a portion of a data center;
processing the input using a first artificial intelligence (AI) model, wherein the first AI model outputs a query instruction based on the natural language query;
obtaining, using the query instruction, first log data from a first device of the data center;
generating, based on the first log data and stored data center configuration information, a response to the natural language query, wherein the response comprises an indication of an error in data center configuration indicating that the at least a portion of the data center has not been configured in accordance with the stored data center configuration information, and the response further comprises the deployment information for the at least the portion of the data center; and
transmitting the response to a client device, wherein the response to the natural language query is visually rendered in a graphical user interface (GUI) of the client device.

2. The method of claim 1, wherein generating the response to the natural language query comprises:
processing the first log data using a second AI model, wherein the second AI model is trained to extract telemetry data from log data and outputs first telemetry data based on the first log data; and
generating the response to the natural language query based on whether a first portion of the first telemetry data matches the first portion of the stored data center configuration information.

3. The method of claim 1, further comprising:
determining that the natural language query is requesting device information for the first device of the data center; and
performing a retrieval augmented generation (RAG) operation on the stored data center configuration information to obtain first device information, wherein the stored data center configuration information comprises a corpus of information for devices of the data center, and wherein generating the response is further based on the first device information.

4. The method of claim 1, wherein the query instruction from the first AI model is a structured query language (SQL) instruction.

5. The method of claim 1, wherein the stored data center configuration information comprises a single source of truth (SSOT) for a data center deployment.

6. The method of claim 5, wherein the SSOT comprises at least one of device information, port connection information, physical location information, or network configuration information.

7. The method of claim 1, further comprising:
causing a visual representation of the at least the portion of the data center to be visually rendered in the GUI, based on the deployment information.

8. The method of claim 1, further comprising:
receiving first data center configuration data;
receiving second data center configuration data; and
generating at least a portion of the stored data center configuration information based on the first data center configuration data and the second data center configuration data.

9. The method of claim 8, further comprising:
visually rendering a first GUI element corresponding to the first data center configuration data, wherein the first GUI element comprises one or more first data entry fields; and
visually rendering a second GUI element corresponding to receiving the second data center configuration data, wherein the second GUI element comprises one or more second data entry fields.

10. The method of claim 1, wherein the query instruction comprises computer-readable instructions that, when executed by the first device, cause the first device to transmit the first log data.

11. One or more processors comprising processing circuitry to perform operations comprising:
receiving first log data from one or more devices of a data center;
processing the first log data using an AI model, wherein the AI model is trained to extract telemetry data from log data and outputs first telemetry data based on the first log data;
generating, based on the first telemetry data and stored data center configuration information, first deployment information for a portion of the data center, wherein the first deployment information comprises an indication of an error in data center configuration indicating that the portion of the data center has not been configured in accordance with the stored data center configuration information; and
responsive to generating the first deployment information, transmitting the first deployment information to a client device, wherein the first deployment information is visually rendered in a graphical user interface (GUI).

12. The one or more processors of claim 11, wherein the operations further comprise:
generating a determination of whether a first portion of the first telemetry data matches a first portion of the stored data center configuration information.

13. The one or more processors of claim 11, wherein the first deployment information comprises first device information, wherein the operations further comprise:
performing a retrieval augmented generation (RAG) operation on the stored data center configuration information to obtain the first device information, wherein the stored data center configuration information comprises a corpus of information for devices of the data center.

14. The one or more processors of claim 11, wherein the operations further comprise:
obtaining the stored data center configuration information from a data structure using a structured query language (SQL) instruction, wherein the AI model is trained to generate the SQL instruction based in part on the first log data.

15. The one or more processors of claim 11, wherein the stored data center configuration information comprises a single source of truth (SSOT) for a data center deployment.

16. The one or more processors of claim 15, wherein the SSOT comprises at least one of device information, port connection information, physical location information, or network configuration information.

17. The one or more processors of claim 11, wherein the operations further comprise:
receiving first data center configuration data;
receiving second data center configuration data; and
generating a portion of the stored data center configuration information based on the first data center configuration data and the second data center configuration data.

18. The one or more processors of claim 17, wherein the operations further comprise:
visually rendering a first GUI element corresponding to the first data center configuration data, wherein the first GUI element comprises one or more first data entry fields; and
visually rendering a second GUI element corresponding to receiving the second data center configuration data, wherein the second GUI element comprises one or more second data entry fields.

19. A system comprising:
a memory; and
one or more processors coupled to the memory, the one or more processors to:
receive a first natural language query, wherein the first natural language query comprises a request for deployment information for at least a portion of a data center;
transmit the first natural language query as a first input to an artificial intelligence (AI) chatbot;
receive a first query instruction from the AI chatbot generated based on the first input;
receive first log data using the first query instruction;
transmit (i) the first natural language query, (ii) the first log data, and (iii) stored data center configuration information as a second input to the AI chatbot;
receive, from the AI chatbot, a first natural language response based on the second input, wherein the first natural language response comprises an indication of an error in data center configuration indicating that the at least a portion of the data center has not been configured in accordance with the stored data center configuration information, and the first natural language response further comprises the deployment information for the at least a portion of the data center; and
transmit the first natural language response to a display of a client device, wherein the first natural language response is visually rendered in a graphical user interface (GUI) on the display of the client device.

20. The system of claim 19, wherein the one or more processors are further to:
extract telemetry data from log data and output first telemetry data based on the first log data;
generate a determination of whether a first portion of the first telemetry data matches a first portion of the stored data center configuration information; and
generate the first natural language response based on whether the first portion of the first telemetry data matches the first portion of the stored data center configuration information.
